(19) United States
(12) Patent Application Publication
(10) Pub. No.: US 2014/0022549 A1
(43) Pub. Date: Jan. 23, 2014

(54) SPECTROMETER

(71) Applicant: Yukihiro Ozeki, Sagamihara-shi (JP)

(72) Inventor: Yukihiro Ozeki, Sagamihara-shi (JP)

(21) Appl. No.: 14/008,947

(22) PCT Filed: Sep. 22, 2011
(86) PCT No.: PCT/JP2011/005339

§ 371 Date: Sep. 30, 2013

(30) Foreign Application Priority Data
Mar. 31, 2011 (JP) 2011-077751
Mar. 31, 2011 (JP) 2011-077752

(51) Int. Cl. G01J 3/51

(52) U.S. Cl. CPC G01J 3/51
USPC 356/416

(57) ABSTRACT

Provided is a spectrometer capable of separating a particular wavelength component from light including a plurality of wavelength components by means of a small, simple configuration. The spectrometer comprises a filter part configured to transmit a specific wavelength component of light incident onto an incident surface. An illuminating means is configured to cause the light to be incident at respectively different incident angles onto a plurality of incident positions at different positions in the longer direction of the incident surface.

### FIELD OF THE INVENTION

The present invention relates to a spectrometer that separates a particular wavelength component from light comprising a plurality of wavelength components.

### BACKGROUND OF THE INVENTION

For example, in various fields that use light such as the spectral analyzer of measurement samples, optical communication, etc., a spectrometer is used in order to separate a particular wavelength component from light comprising a plurality of wavelength components.

In the field of optical communication, by means of wavelength division multiplexing (hereinafter, referred to as “WDM”) that simultaneously transmits light comprising a plurality of wave length components, it becomes possible to transmit massive information via a single optical fiber. Different signals respectively correspond to the plurality of wavelength components.

The spectrometer is used for selectively detecting a particular wavelength component from the plurality of wavelength components transmitted by WDM.

For example, an Optical performance monitoring device (hereinafter, referred to as “OPM”) comprising a spectrum function is mentioned in cited Document 1.

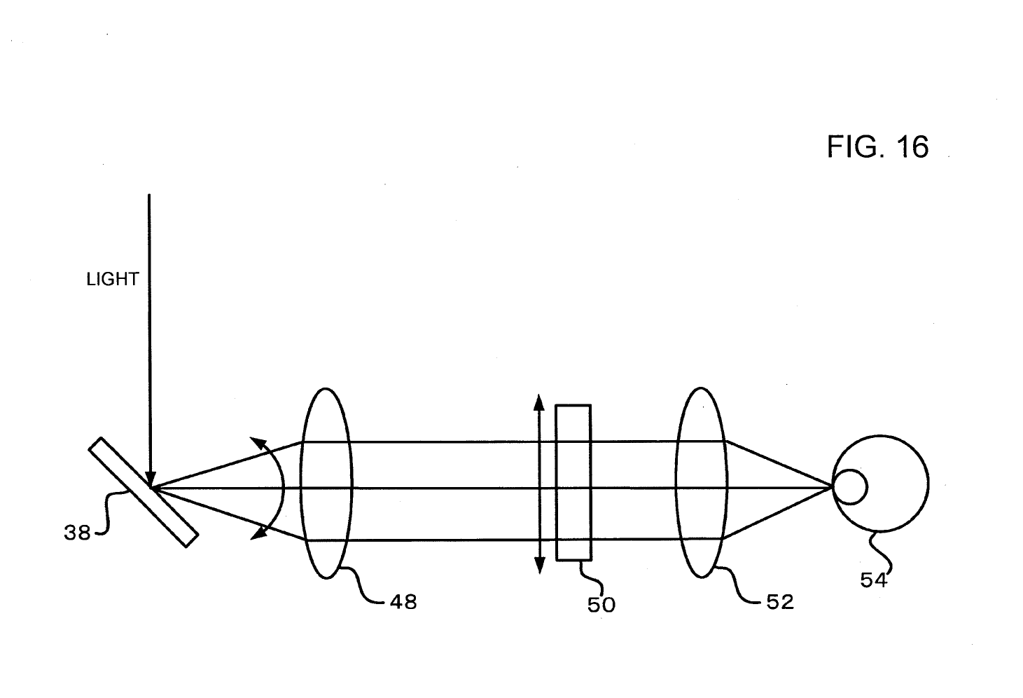

The OPM according to cited Document 1 transmits incident light in a specific direction using a cyclically pivotable mirror 38, perpendicularly entering the incident light into a LVF (linear variable filter) 50 via a lens 48. Then, the light of the specific wavelength penetrating through the LVF 50 is received by a photodetector 54 via a lens 52 and, thereby, the particular wavelength component is detected from the light comprising a plurality of wavelength components (refer to FIG. 16).

### PRIOR ART DOCUMENTS

### Patent Documents

[Patent Document 1] U.S. Pat. No. 6,836,349

### SUMMARY OF THE INVENTION

### Problem to be Solved by the Invention

However, regarding the technology according to Patent Document 1, the lens 48 for perpendicularly entering the light into the LVF50 becomes necessary (refer to FIG. 16). Accordingly, a space for arranging the lens is necessary, resulting in a problem of the spectrometer increasing in size and becoming complicated.

Moreover, in the field of optical communication, etc., technology is required for effectively extracting only a particular wavelength component from among broadband light comprising a plurality of different wavelength components (for example, several hundred). However, a one-dimensional LVF50 is used in the technology according to Patent Document 1; therefore, a long LVF must be provided in order to penetrate the wavelength component included in the broadband light. Moreover, the lens 48 adjusted to the LVF thereof must be arranged. That is, there was a concern regarding the increased size and increased complication of the device as a result of increasing the size of each member.

In order to solve the problems mentioned above, the purpose of the present invention is to provide a spectrometer capable of separating a particular wavelength component from light comprising a plurality of wavelength components by means of a small, simple configuration.

Moreover, the purpose of the present invention is to provide a spectrometer capable of separating the particular wavelength component from the broadband light by means of a small, simple configuration.

### Means of Solving the Problem

In order to solve the problems mentioned above, the spectrometer according to claim 1 comprises: a filter part configured to transmit a specific wavelength component of light incident onto an incident surface; and an illuminating means configured to cause the light to be incident at respectively different incident angles onto a plurality of incident positions at different positions in the longer direction of the incident surface.

Moreover, in order to solve the problems mentioned above, the spectrometer according to claim 2 is the spectrometer according to claim 1, wherein the illuminating means comprises: a mirror part configured to reflect the light; and a driving mechanism configured to drive the mirror part such that the light is successively incident onto the plurality of incident positions.

Moreover, in order to solve the problems mentioned above, the spectrometer according to claim 3 is the spectrometer according to claim 1, wherein the illuminating means substantially simultaneously causes the light to be incident onto the plurality of incident positions.

Moreover, in order to solve the problems mentioned above, the spectrometer according to claim 4 is the spectrometer according to claim 1, and comprises a reflection member configured to be formed with a reflective surface that reflects light penetrated the filter part, wherein the illuminating means is arranged on the first surface side of the filter part, the reflection member is arranged on the second surface side that is the opposite side of the first surface, and the reflective surface faces the second surface and is non-parallelly arranged with respect to the incident surface. Further, the characteristic mentioned in claim 4 may be applied to the spectrometer according to claim 2 or claim 3.

Moreover, in order to solve the problems mentioned above, the spectrometer according to claim 5 is the spectrometer according to claim 4, wherein the reflective surface is non-parallelly arranged with respect to the incident surface such that while guiding the light reflected from the reflective surface to a photo detector, the surface-reflected light of the light from the first surface side is not incident onto the photo detector.

Moreover, in order to solve the problems mentioned above, the spectrometer according to claim 6 is the spectrometer according to claim 1, wherein the filter part is a linear variable wavelength filter. Further, the characteristic mentioned in claim 6 may be applied to the spectrometer according to any of claims 2 to 5.

Moreover, in order to solve the problems mentioned above, the spectrometer according to claim 7 is the spectrometer according to claim 1, and comprises a plurality of photo detectors configured to be arranged at positions corresponding to the plurality of incident positions and to receive the light penetrated the filter part. Further, the characteristic mentioned in claim 7 may be applied to the spectrometer according to any of claims 2 to 6.

Moreover, the spectrometer according to claim 8 comprises a filter part configured to transmit a particular wavelength component of the light incident onto an incident surface with two-dimensional expanse; and an illuminating means configured to cause the light to be incident at respectively different incident angles onto a plurality of incident positions on the incident surface that are two-dimensionally different positions.

Moreover, in order to solve the problems mentioned above, the spectrometer according to claim 9 is the spectrometer according to claim 8, wherein the illuminating means comprises: a mirror part configured to reflect the light; and a driving mechanism configured to drive the mirror part such that the light is successively incident onto the plurality of incident positions.

Moreover, in order to solve the problems mentioned above, the spectrometer according to claim 10 is the spectrometer according to claim 8, wherein the illuminating means substantially simultaneously causes the light to be incident onto the plurality of incident positions.

Moreover, in order to solve the problems mentioned above, the spectrometer according to claim 11 is the spectrometer according to claim 8, and comprises a reflection member configured to be formed with a reflective surface that reflects light penetrated the filter part, wherein the illuminating means is arranged on the first surface side of the filter part, the reflection member is arranged on the second surface side that is the opposite side of the first surface, and the reflective surface faces the second surface and is non-parallelly arranged with respect to the incident surface. Further, the characteristic mentioned in claim 11 may be applied to the spectrometer according to claim 9 or claim 10.

Moreover, in order to solve the problems mentioned above, the spectrometer according to claim 12 is the spectrometer according to claim 11, wherein the reflective surface is non-parallelly arranged with respect to the incident surface such that while guiding the light reflected from the reflective surface to a photo detector, the surface-reflected light of the light from the first surface side is not incident onto the photo detector.

Moreover, in order to solve the problems mentioned above, the spectrometer according to claim 13 is the spectrometer according to claim 8, wherein the filter part is the linear variable wavelength filter. Further, the characteristic mentioned in claim 13 may be applied to the spectrometer according to any of claims 9 to 12.

Moreover, in order to solve the problems mentioned above, the spectrometer according to claim 14 is the spectrometer according to claim 8, and comprises a plurality of photo detectors configured to be arranged at positions corresponding to the plurality of incident positions and to receive the light penetrated the filter part. Further, the characteristic mentioned in claim 14 may be applied to the spectrometer according to any of claims 9 to 13.

Moreover, in order to solve the problems mentioned above, the spectrometer according to claim 15 is the spectrometer according to claim 8, wherein the filter part comprises a plurality of filters configured to comprise a substantially linear incident surface in which the longer direction is a specific direction and to transmit particular wavelength components of the light incident onto the incident surface, transmission wavelength components of the plurality of filters are different from each other, and the plurality of filters are arranged in a direction orthogonal to the specific direction. Further, the characteristic mentioned in claim 15 may be applied to the spectrometer according to any of claims 9 to 14.

Moreover, in order to solve the problems mentioned above, the spectrometer according to claim 16 is the spectrometer according to claim 8, wherein the filter part comprises a single filter having an incident surface with two-dimensional expanse, this filter is formed such that center wavelengths of transmission wavelength components are different along a first direction on the incident surface, and center wavelengths of transmission wavelength components are equal along a second direction that is orthogonal to the first direction. Further, the characteristic mentioned in claim 16 may be applied to the spectrometer according to any of claims 9 to 14.

### Effects of the Invention

According to the present invention, the spectrometer comprises a filter part that transmits a specific wavelength component of light incident onto an incident surface. An illuminating means causes the light to be incident at respectively different incident angles onto a plurality of incident positions that are different positions in the longer direction of the incident surface. Accordingly, there is no need to provide a conventional lens; consequently, by means of a small scale and simple configuration, the particular wavelength component may be separated from the light comprising the plurality of wavelength components.

Moreover, the spectrometer according to the present invention comprises a filter part that transmits a particular wavelength component of the light incident onto an incident surface with two-dimensional expanse. An illuminating means causes the light to be incident at respectively different incident angles onto a plurality of incident positions on the incident surface that are two-dimensionally different positions. Accordingly, there is no need to provide a conventional lens; consequently, by means of a small scale and simple configuration, the particular wavelength component may be separated from the broadband light.

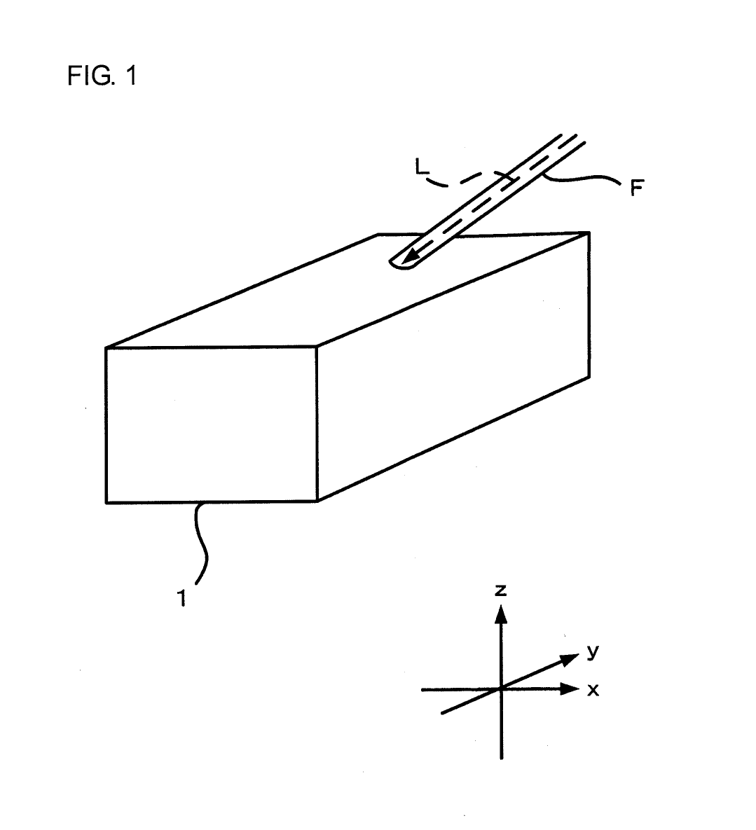

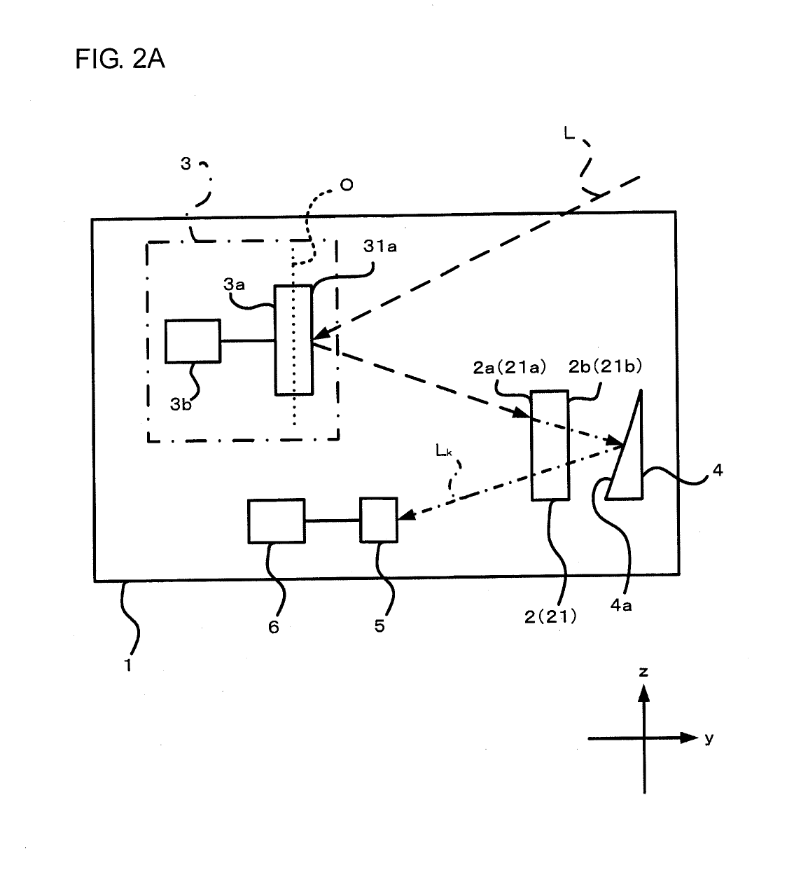

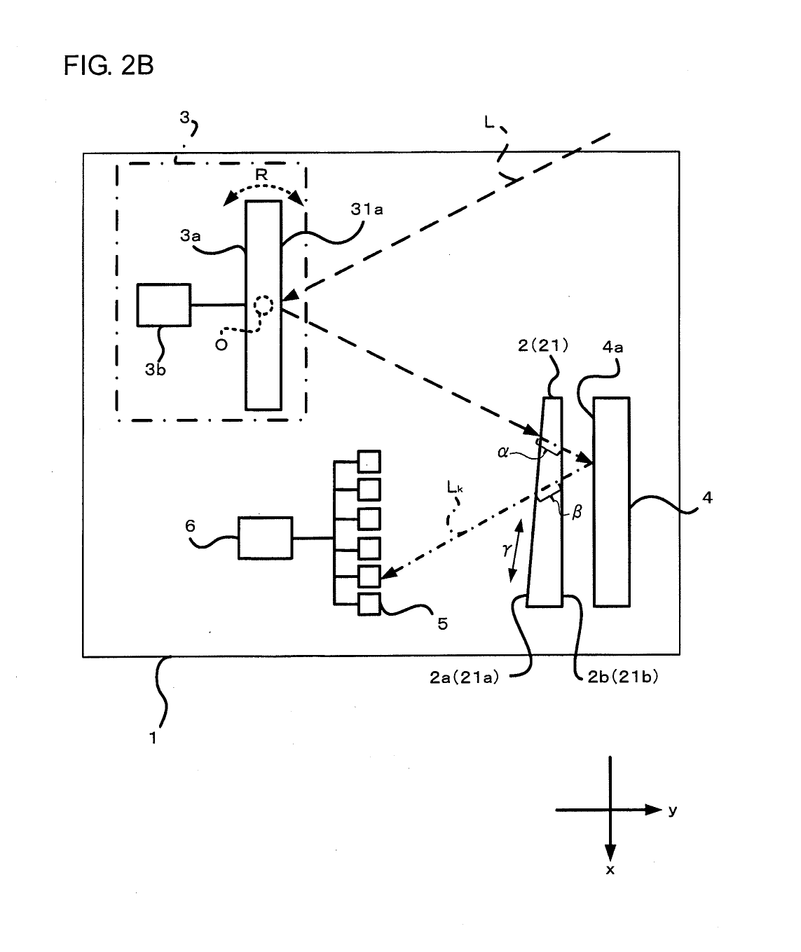

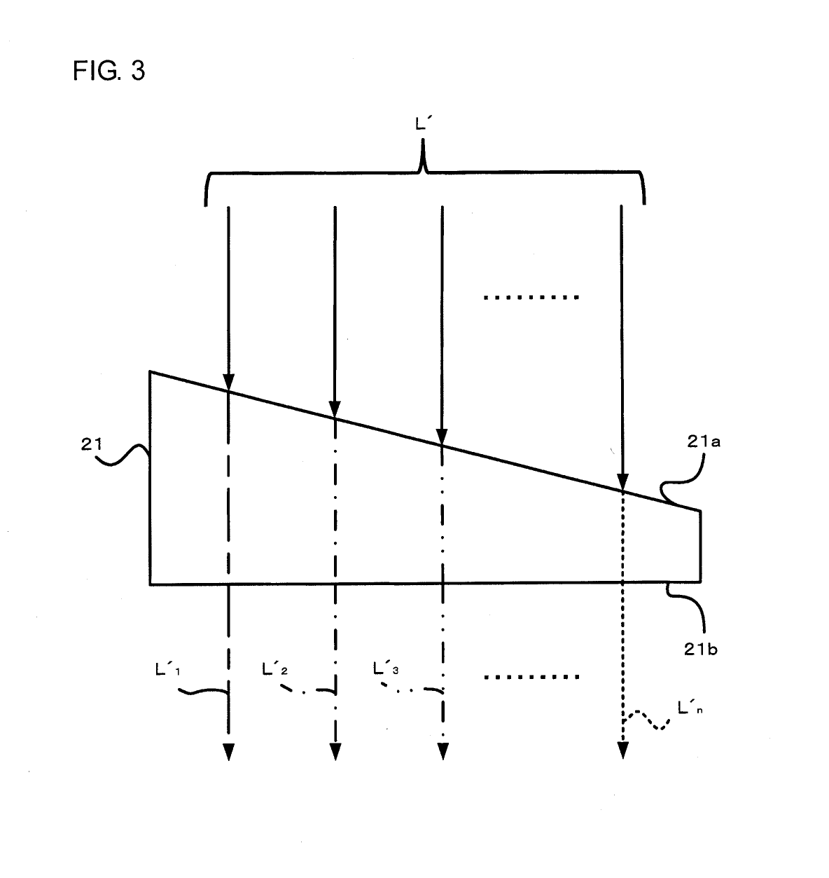

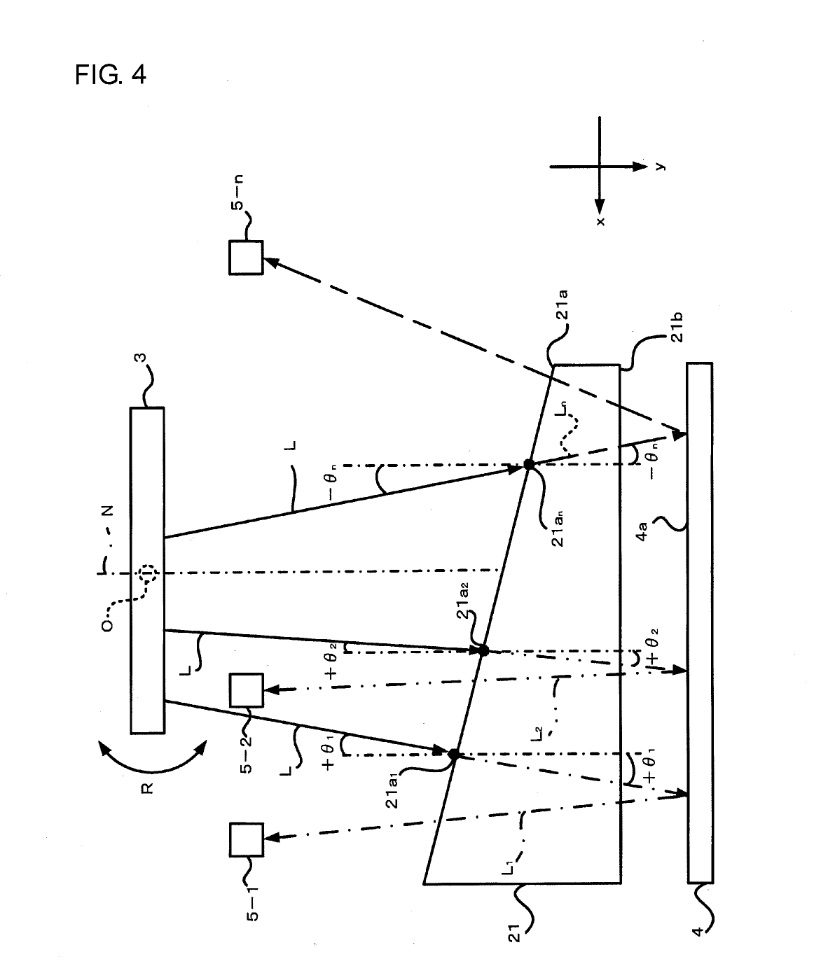

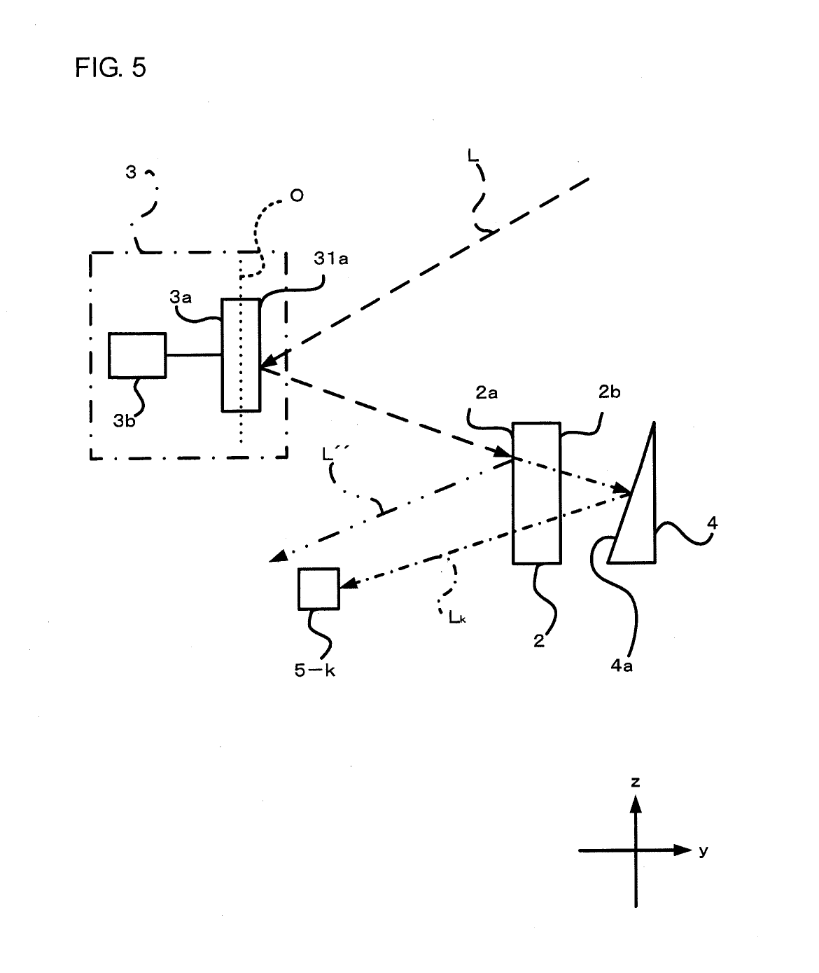

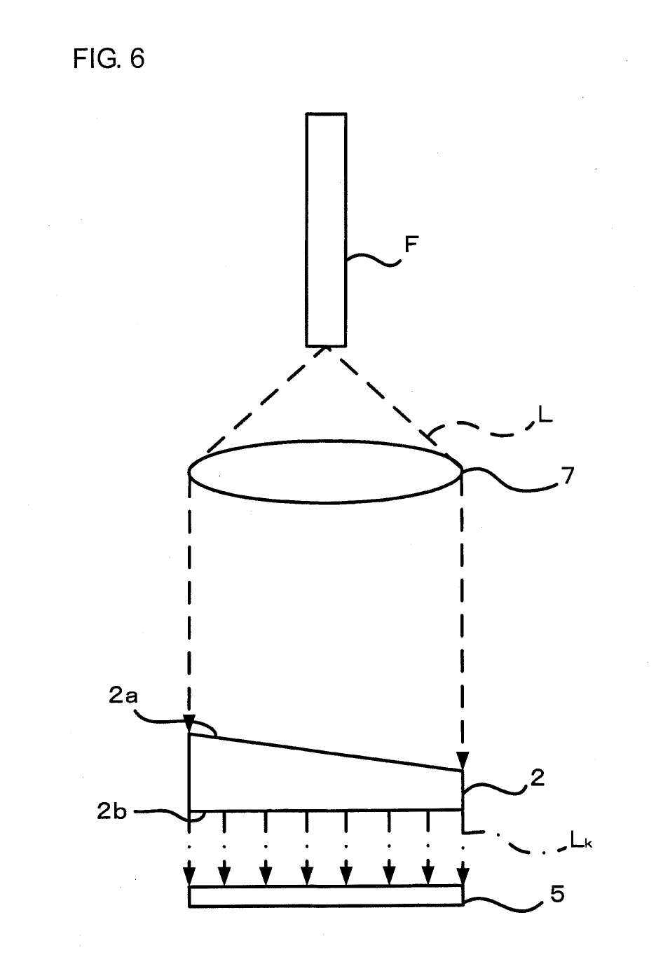

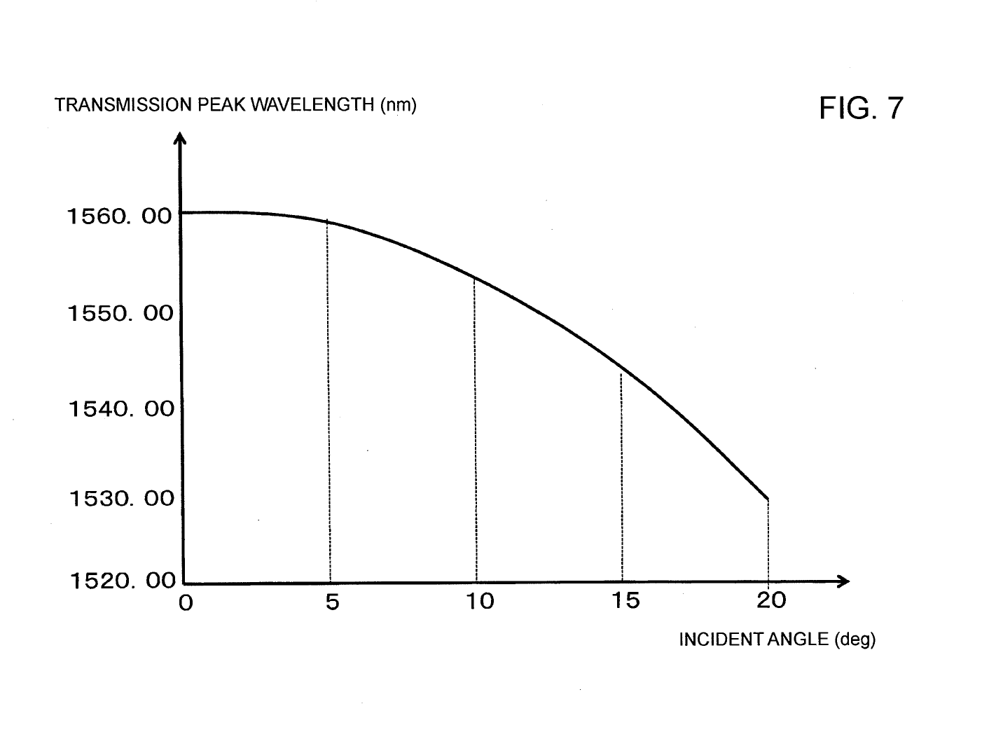

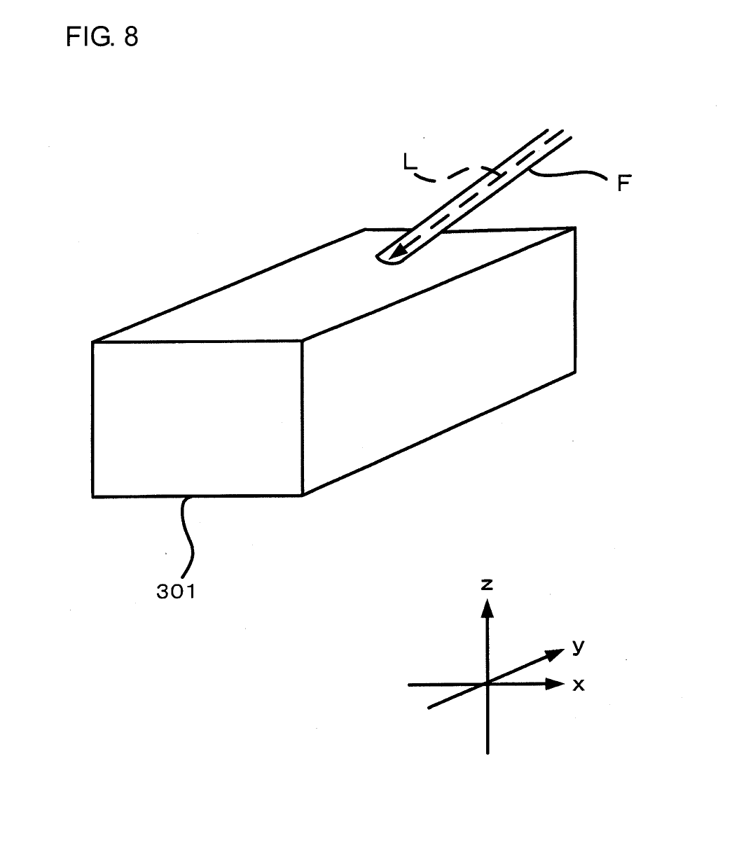

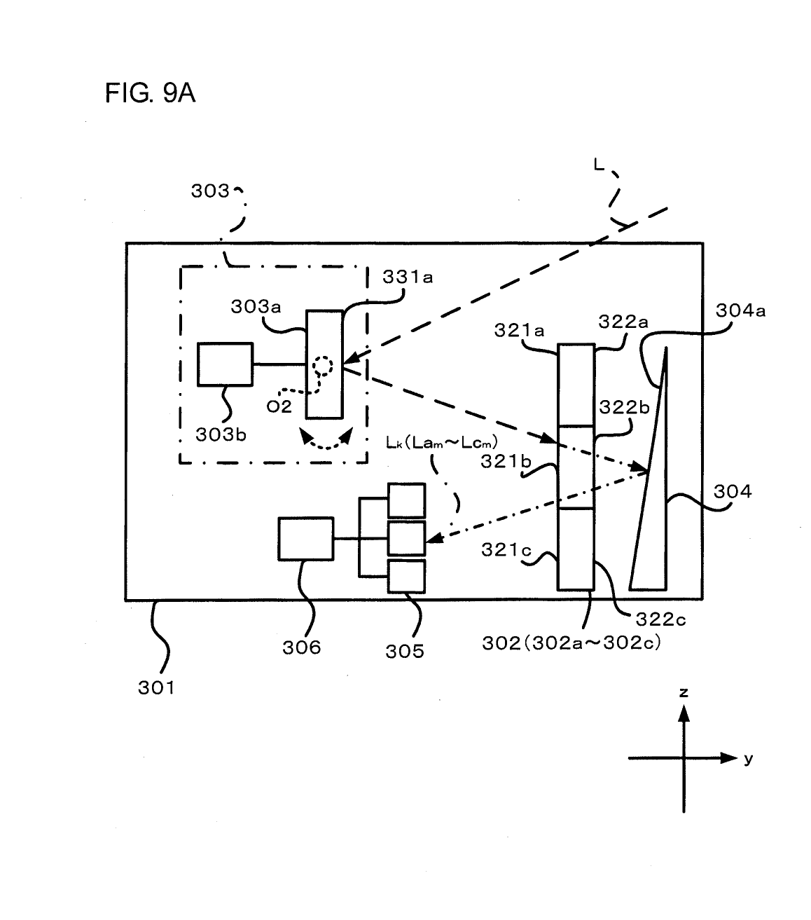

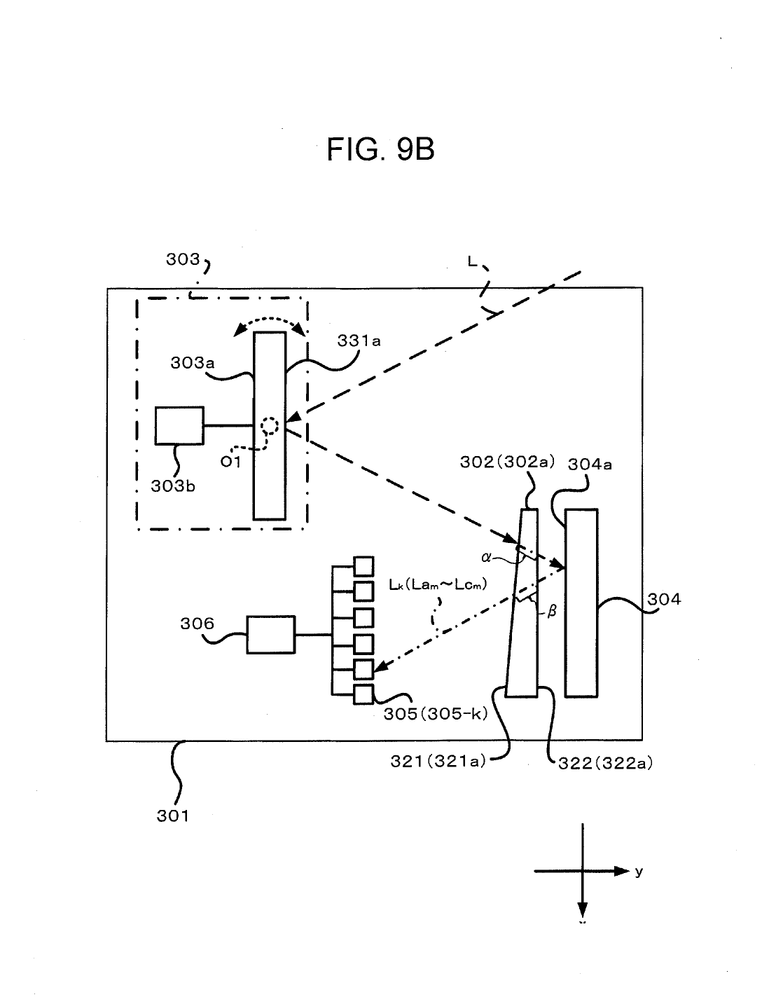

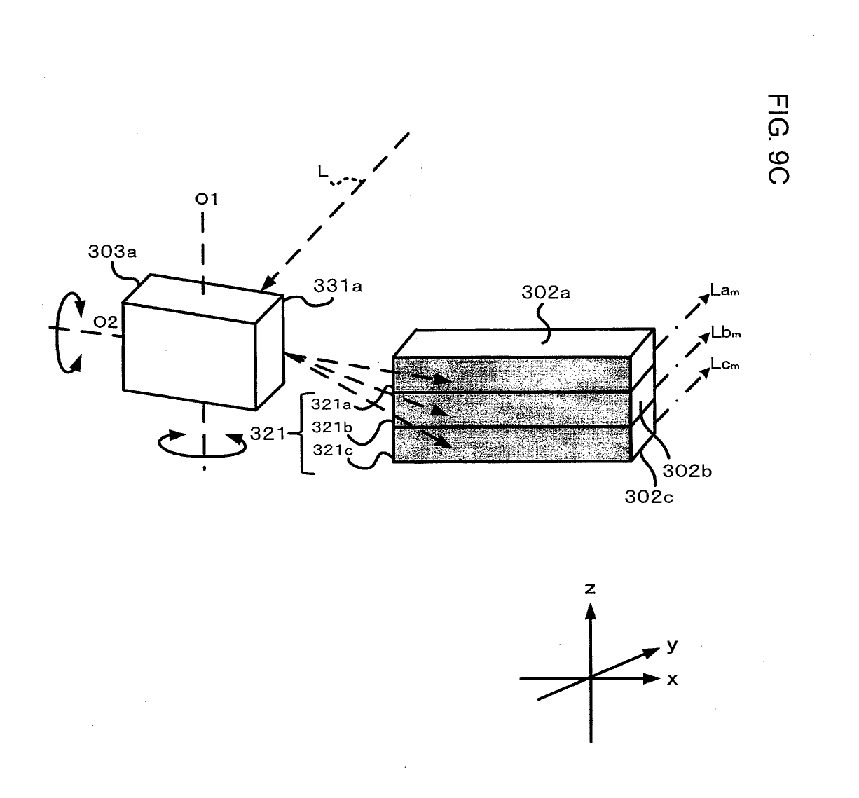

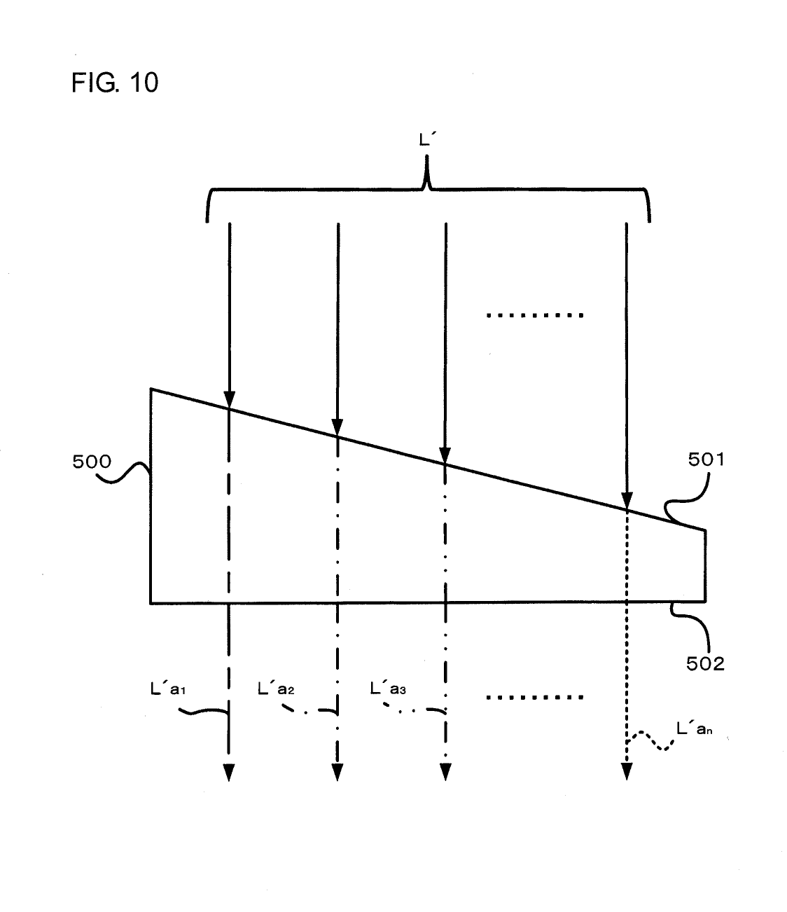

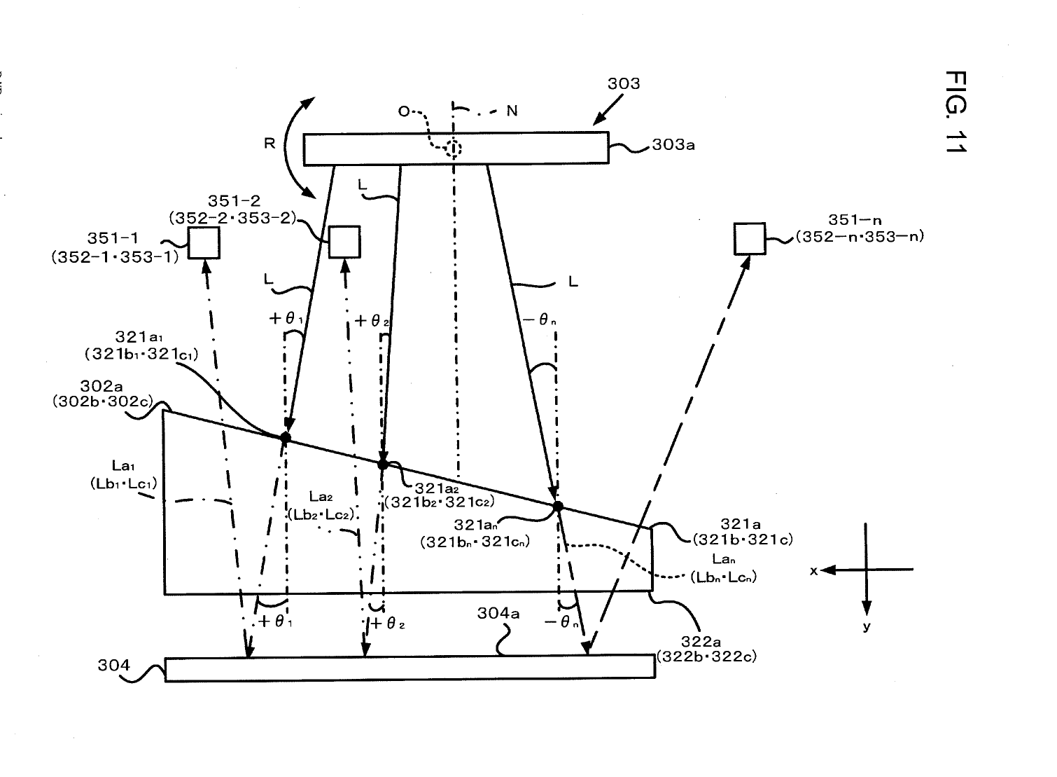

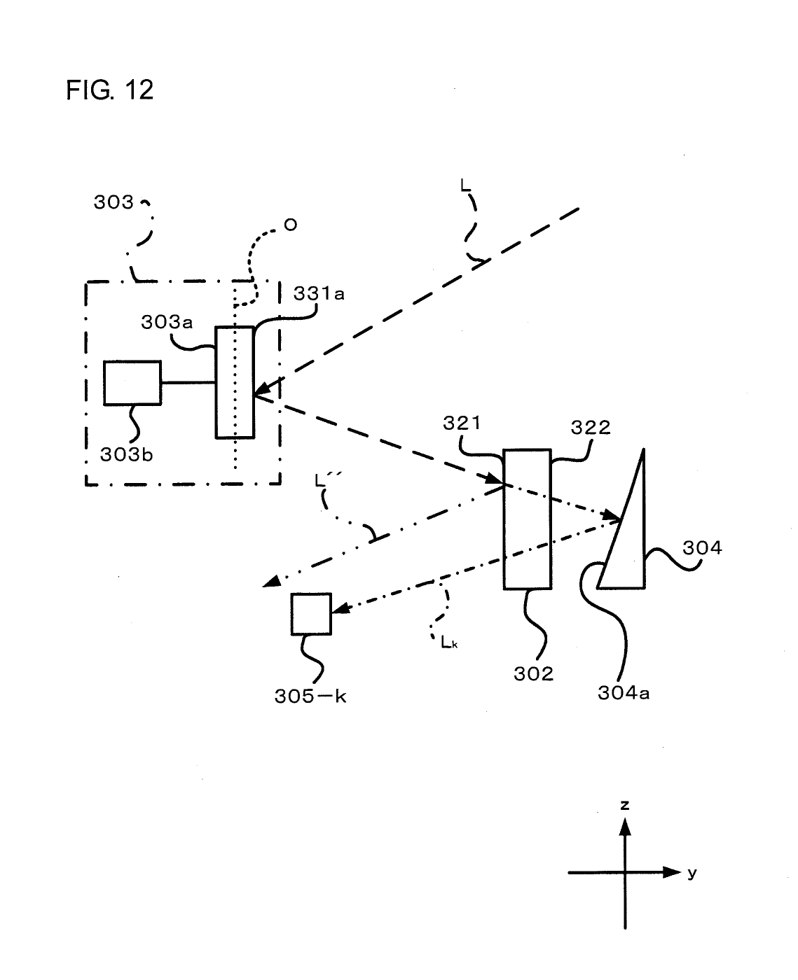

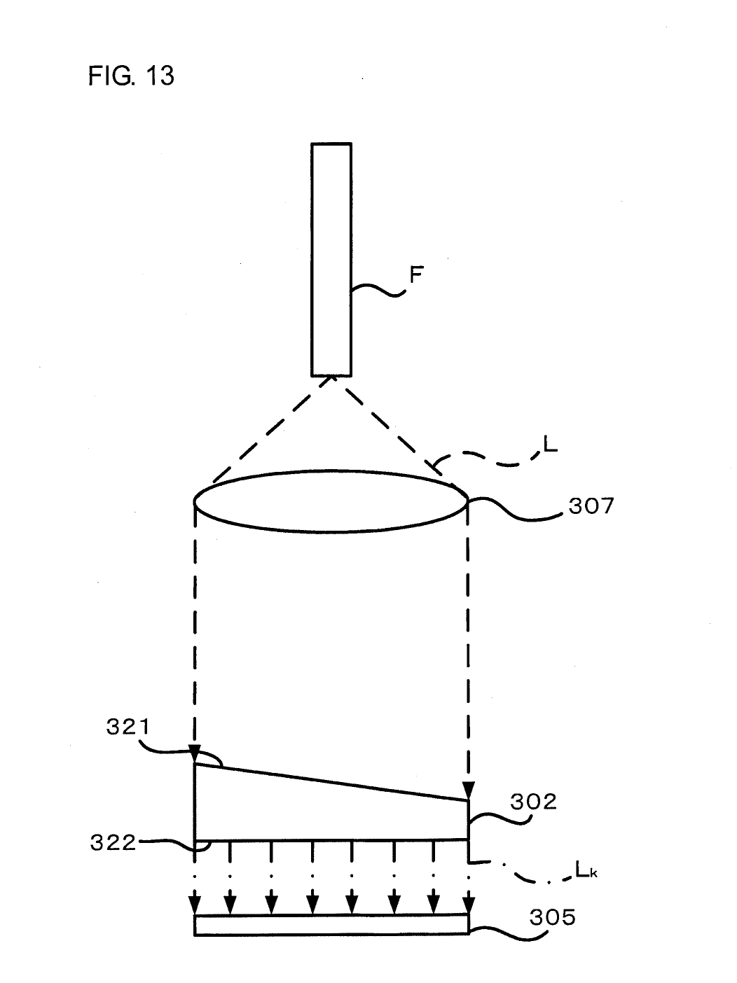

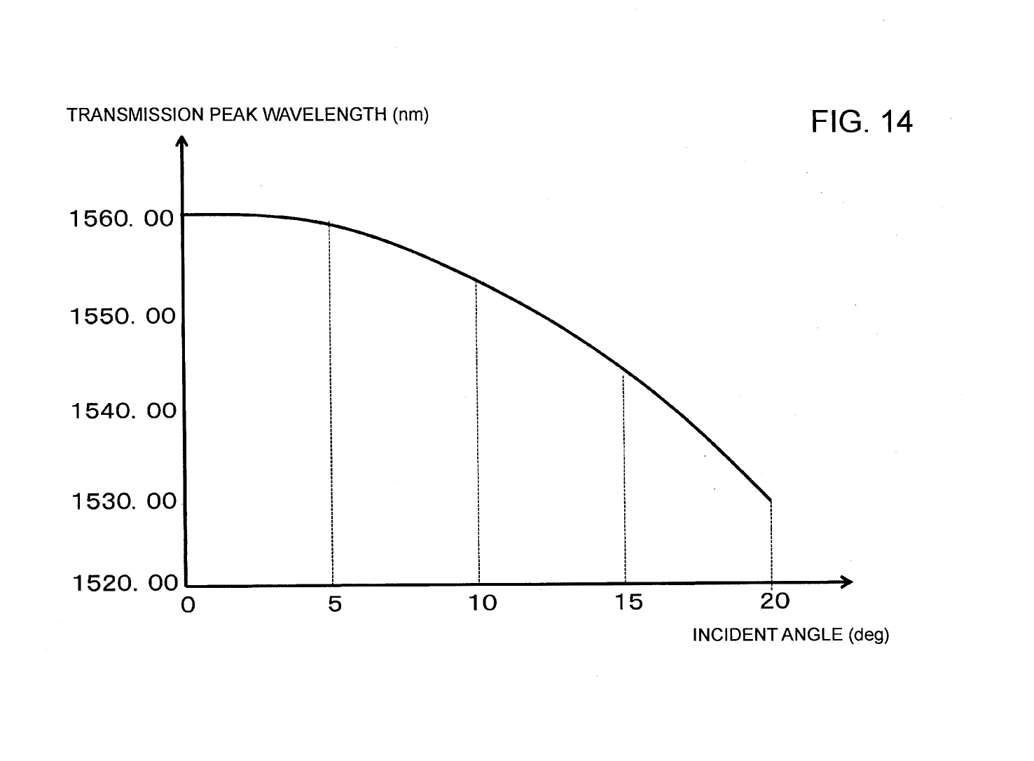

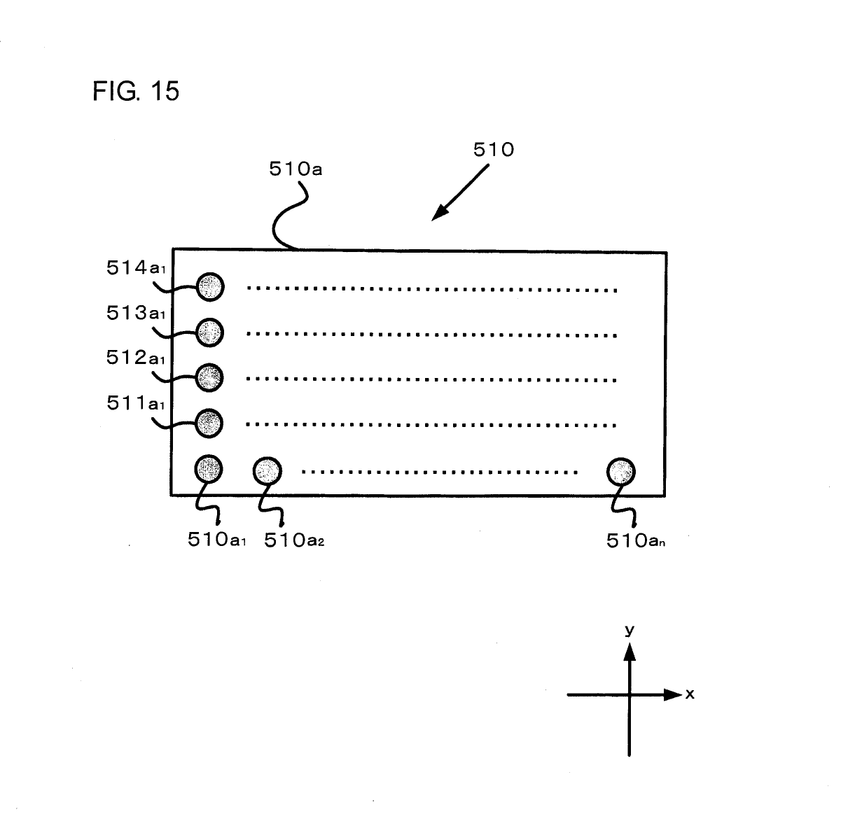

### BRIEF DESCRIPTION OF THE DRAWINGS

[FIG. 1] is a perspective diagram of the spectrometer according to the First Embodiment.

[FIG. 2A] is a side view of the spectrometer according to the First Embodiment.

[FIG. 2B] is a top view of the spectrometer according to the First Embodiment.

[FIG. 3] is a diagram illustrating the configuration of the filter part according to the First Embodiment.

[FIG. 4] is a diagram explaining the progression of light in the spectrometer according to the First Embodiment.

[FIG. 5] is a diagram explaining the progression of light in the spectrometer according to the First Embodiment.

[FIG. 6] is a diagram illustrating a part of the configuration of the spectrometer according to Modified Example 1.

[FIG. 7] is a diagram illustrating the change of the center wavelength of the band pass filter characteristic with respect to the incident angle in the spectrometer according to Modified Example 2.

[FIG. 8] is a perspective diagram of the spectrometer according to the Second Embodiment.

[FIG. 9A] is a side view of the spectrometer according to the Second Embodiment.

[FIG. 9B] is a top view of the spectrometer according to the Second Embodiment.

[FIG. 9C] is a perspective diagram of the inside of the spectrometer according to the Second Embodiment.

[FIG. 10] is a diagram illustrating the configuration of the filter part according to the Second Embodiment.

[FIG. 11] is a diagram explaining the progression of light in the spectrometer according to the Second Embodiment.

[FIG. 12] is a diagram explaining the progression of light in the spectrometer according to the Second Embodiment.

[FIG. 13] is a diagram illustrating a part of the configuration according to Modified Example 1.

[FIG. 14] is a diagram illustrating the change of the center wavelength of the band pass filter characteristic with respect to the incident angle in the spectrometer according to Modified Example 2.

[FIG. 15] is a diagram illustrating the configuration of the filter part in the spectrometer according to Modified Example 3.

[FIG. 16] is a diagram illustrating the optical system related to the conventional technology.

### MODE FOR CARRYING OUT THE INVENTION

### <First Embodiment>

The spectrometer related to a First Embodiment is explained with reference to FIGS. 1 to 5.

As illustrated in FIG. 1, FIG. 2A and FIG. 2B, the spectrometer 1 of the present embodiment comprises a filter part 2, an illuminating means 3, a reflection member 4, a photo detector 5, and a spectral analyzer 6. FIG. 1 is a perspective diagram illustrating an example of the spectrometer 1. FIG. 2A is a side view of the spectrometer 1 (y-z direction in FIG. 1). FIG. 2B is a top view of the spectrometer 1 (x-y direction in FIG. 1). The dashed arrows in FIG. 1, FIG. 2A and FIG. 2B schematically illustrate an example of the pathway of the light L incident into the spectrometer 1 via a fiber F (refer to FIG. 1). The chain line arrows in FIG. 1 and FIG. 2 schematically illustrate an example of the pathways of the wavelength components Lₖ (k=1 to n) that have passed through the filter part 2.

### <Filter Part>

Inside the spectrometer 1, the filter part 2 is arranged in the position into which the light L from the illuminating means 3 is incident. It should be noted that the present embodiment and Modified Example 1 explain configurations using a linear variable wavelength filter 21 as the filter part 2. Moreover, Modified Example 2 explains a configuration using a band pass filter with uniform transmission characteristic.

The filter part 2 comprises a first surface 2a and a second surface 2b. The first surface 2a and the second surface 2b are on opposite sides of each other. The light L from the illuminating means 3 is incident into the first surface 2a. That is, the first surface 2a forms the incident surface of the filter part 2 (hereinafter, referred to as an “incident surface 2a”). There are multiple positions on the incident surface 2a into which the light L is incident (hereinafter, referred to as “incident positions”). The filter part 2 transmits particular wavelength components Lₖ of the light L incident with respect to the incident surface 2a. From among the light L incident from the incident surface 2a, only the particular wavelength components Lₖ are output from the second surface 2b. That is, the second surface 2b forms an output surface of the filter part 2 (hereinafter, referred to as an “output surface 2b”). The illuminating means 3 is arranged on the incident surface 2a side apart from the filter part 2 by a predetermined distance. The reflection member 4 is arranged on the output surface 2b side apart from the filter part 2 by a predetermined distance.

It should be noted that, practically, the thickness of the filter part 2 is formed thinner than the length of the optical path of the light L (the distance passed by the light L is shorter). Moreover, the distance between the reflection member 4 and the output surface 2b is formed shorter compared to the distance between the illuminating means 3 and the incident surface 2a. Accordingly, the wavelength component Lₖ penetrating through the filter part 2 from the incident surface 2a side and reflected by the reflection member 4 penetrates the filter part 2 from the output surface 2b side via the pathway β (refer to FIG. 2B) that is substantially the same as the pathway α (refer to FIG. 2B) of this wavelength component Lₖ penetrating the filter part 2 from the incident surface 2a side, and reaches the photo detector 5 (in each diagram, the depiction is exaggerated for easier understanding of the invention).

Here, a general configuration of the linear variable wavelength filter 21 is explained using FIG. 3. FIG. 3 is a diagram illustrating when looking at the filter part 2 (linear variable wavelength filter 21) from the top of the spectrometer 1.

The linear variable wavelength filter 21 comprises an incident surface 21a (the first surface 2a) and an output surface 21b (the second surface 2b). Light L′ from the illuminating means 3 is incident into the incident surface 21a. The incident direction thereof is determined from the direction of a reflective surface 31a (mentioned later) of the illuminating means 3. The incident surface 21a is inclined by a specific degree with respect to the longer direction of the output surface 21b (the second surface 2b) on the opposite side thereof. Even when the light L comprising multiple wavelength components L′ₖ (k=1 to n) from the incident surface 21a is incidented, the penetrating wavelength components L′ₖ differ depending on the incident positions thereof (refer to FIG. 3). That is, the linear variable wavelength filter 21 is capable of separating the light comprising a plurality of wavelength components into particular wavelength components.

### <Illuminating Means>

The illuminating means 3 causes the light L guided by the optical fiber F, etc. and incident into the spectrometer 1 to be incident at respectively different incident angles with respect to the plurality of incident positions that are different positions in the longer direction (γ direction of FIG. 2B) of the incident surface 2a. The incident angle of the present embodiment is an angle expressed by the inclination of the light L with respect to a normal line, with this normal line when the illuminating means 3 is at the initial position as the standard. It should be noted that the “initial position” refers to the position of a mirror part 3a when, for example, the output surface 2b of the filter part 2 and the reflective surface 31a of the mirror part 3a are parallel.

The illuminating means 3 comprises the mirror part 3a and a driving mechanism 3b. The mirror part 3a comprises the reflective surface 31a that reflects the light L incident into the spectrometer 1. The driving mechanism 3b rotates the mirror part 3a with respect to an axis of rotation O (refer to FIG. 2A and FIG. 2B) based on a control signal from a controller (not illustrated), etc., thereby successively causing the light L reflected by the reflective surface 31a to be incident into the plurality of incident positions provided on the incident surface 2a. The illuminating means 3 is, for example, a MEMS (Micro Electro Mechanical Systems) mirror or a polygon mirror.

Moreover, it is possible to apply a configuration in which the illuminating means 3 does not comprise the driving mechanism 3b. As an example thereof, a diverging member, such as a concave lens, capable of diverging the light L is arranged at the output end of the optical fiber F that guides the light L into the spectrometer 1. Moreover, the illuminating means 3 is a member such as a mirror, etc. The illuminating means 3 is fixed in a position capable of simultaneously causing the light L diverged by the diverging member with respect to the plurality of incident positions on the incident surface 2a. it should be noted that, in this case, the timings for detecting the plurality of wavelength components Lₖ included in the light L irradiated at a certain timing using the photo detector 5 may be the same. Accordingly, the light L may be substantially simultaneously incident into the plurality of incident positions on the incident surface 2a.

Here, in the case of causing the diverged light to be incident into the filter part 2 (the incident surface 2a), there is a possibility of the amount of light incident into the edge part of the incident surface 2a being weaker compared to the central part of the incident surface 2a. In such cases, by, for example, considering the distribution of the intensity of light L projected onto the incident surface 2a with respect to the result of light reception by the photo detector 5 in the spectral analyzer 6, it is possible to perform a correction processing using coefficients for cancelling this distribution, thereby suppressing the dispersion of light intensity.

### <Reflection Member>

The reflection member 4 is an optical element such as a mirror, etc. The reflection member 4 is arranged on the output surface 2b side of the filter part 2. The reflection member 4 is formed with a reflective surface 4a that reflects the wavelength component Lₖ that has passed through the filter part 2. The reflective surface 4a faces the output surface 2b, and is parallelly arranged with respect to the longer direction thereof (refer to FIG. 2B). As a result, the reflective surface 4a is non-parallelly arranged with respect to the incident surface 2a (refer to FIG. 2A and FIG. 2B). As described above, the wavelength component Lₖ reflected by the reflective surface 4a is guided to the photo detector 5 via the pathway β (refer to FIG. 2B) which is substantially the same as the pathway α (refer to FIG. 2B), in which the light L penetrates the filter part 2. The reflection member 4 is formed with the same length as the length in the longer direction of the output surface 2b such that the wavelength component Lₖ output from the output surface 2b may be reflected.

By means of arranging the reflection member 4 on the output surface 2b side of the filter part 2, the wavelength component Lₖ corresponding to a particular wavelength λₖ (k=1 to n) that has penetrated the filter part 2 is reflected by the reflection member 4 and is incident into the filter part 2 again from the output surface 2b side. Accordingly, even when only the wavelength component Lₖ corresponding to the particular wavelength λₖ cannot have been separated by causing the light L to be incident from the incident surface 2a side of the filter part 2 (that is, even when so-called crosstalk occurs), by means of penetrating the wavelength component Lₖ through the filter part 2 again (by causing it to be incident from the output surface 2b side), it becomes possible to transmit only the wavelength component Lₖ corresponding to the particular wavelength λₖ. That is, the detection selectivity of the wavelength component may be enhanced.

### <Photo Detector>

The photo detector 5 receives the wavelength components Lₖ that have penetrated the filter part 2. The photo detector 5 is, for example, a PD (Photo Detector). The photo detector 5 is provided in pluralities in the position corresponding to the plurality of incident positions on the incident surface 2a (refer to FIG. 2B). That is, there is a one-to-one correspondence between the plurality of photo detectors 5−k (k=1 to n) and the plurality of incident positions.

Here, in Patent Document 1, when detecting particular wavelength components, it is difficult to determine whether or not light may be accurately projected onto the positions of the LVF50 corresponding to the wavelength components thereof and further, to determine whether or not the particular wavelength components have passed through the corresponding positions thereof. Accordingly, calibration between the angle of the cyclically pivotable mirror 38 with respect to the LVF50 is required each time the spectrometer is used, making it troublesome for the user; moreover, there is also a concern that this may lead to declined detection accuracy.

In contrast, the position of the photo detector 5 of the present embodiment is associated with the incident position of the light L with regard to the filter part 2, allowing the photo detector 5 receiving the wavelength component Lₖ included in the light L incident into a certain incident position to be determined. Accordingly, it becomes possible to separate the particular wavelength component Lₖ from the light L comprising the plurality of wavelength components L₁ to Lₙ without having to carry out calibration between the illuminating means 3 and the filter part 2.

### <Spectral Analyzer>

The spectral analyzer 6 analyzes electrical signals based on the wavelength component Lₖ received by the photo detector 5 to extract information included in this wavelength component Lₖ.

It should be noted that, in the present embodiment, an explanation has provided for a configuration of the spectrometer 1 comprising the filter part 2, the illuminating means 3, the reflection member 4, the photo detector 5, and the spectral analyzer 6; however, the configuration of the spectrometer 1 is not limited to this. For example, if the photo detector 5 is arranged on the output surface 2b side of the filter part 2, the reflection member 4 is not required. Accordingly, the configuration of the spectrometer 1 may be simplified. In this case as well, the photo detector 5 is provided in pluralities in the positions corresponding to the plurality of incident positions of the incident surface 2a.

Moreover, the photo detector 5 and the spectral analyzer 6 may be provided as a different body from the spectrometer 1 (for example, outside the spectrometer 1). That is, it is sufficient to comprise at least the filter part 2 and the illuminating means 3 as a spectrometer of the present invention.

### <Progression of Light>

Next, the progression of the light L in the spectrometer 1 of the present embodiment is explained with reference to FIG. 4. FIG. 4 is a diagram illustrating the inside of the spectrometer 1 as seen from the top side (x-y direction). It should be noted that, in FIG. 4, n rays of light L are illustrated such that they are reflected at different positions on the illuminating means 3 for the convenience of explanation; however, in actuality, each light L is reflected at substantially the same position on the illuminating means 3. In the configuration illustrated in FIG. 4, a linear variable wavelength filter 21 is used as the filter part 2 and the MEMS mirror is used as the illuminating means 3. FIG. 4 illustrates an example of light L, which is obtained by putting the plurality of wavelength components L₁ to Lₙ incident into the spectrometer 1 via the optical fiber F together, penetrating the linear variable wavelength filter 21 from the illuminating means 3, with the wavelength component Lₖ separated by this filter being reflected by the reflection member 4, and leading to the photo detector 5-k (k=1 to n). It is supposed that there are n number of incident positions on the incident surface 21a of the linear variable wavelength filter 21. These are regarded as the incident positions 21aₖ (k=1 to n). Regarding the incident angle θₖ (k=1 to n) at which the light L is incident with respect to the incident position 21aₖ, the inclination of light L incident from the direction, in which the thickness of the linear variable wavelength filter 21 becomes thicker with respect to a normal line N when the MEMS mirror is in the initial position, is regarded as positive, while the inclination of light L incident from the direction, in which the thickness of the linear variable wavelength filter 21 becomes thinner with respect to the normal line N, is regarded as negative. In FIG. 4, refraction at the boundary surface of the linear variable wavelength filter 21 (the incident surface 21a and the output surface 21b) is ignored. It should be noted that FIG. 4 is a diagram illustrating the inside of the spectrometer 1 as seen from the top side, wherein the illuminating means 3, the linear variable wavelength filter 21, the reflection member 4, and the photo detectors 5−k are illustrated such that they seem to be arranged on the same plane; however, in actuality, the respective z positions are different, as illustrated in FIG. 2A.

First, move the mirror part 3a of the MEMS mirror from the initial position to the first position. The “first position” is the position (direction) of the mirror part 3a in which the light L from the optical fiber may be incident into the first incident position 21a₁ on the incident surface 21a of the linear variable wavelength filter 21.

The light L from the optical fiber is guided to the mirror part 3a that is located at the first position. The mirror part 3a causes the light L from the optical fiber to be incident at the incident angle +θ₁ with respect to the first incident position 21a₁.

In the first incident position 21a₁, from among the incident light L, only the first wavelength component L₁ penetrates the linear variable wavelength filter 21 and leads to the reflection member 4. The reflection member 4 (the reflective surface 4a) reflects the wavelength component L₁ and causes it to be incident into the output surface 21b of the linear variable wavelength filter 21. The wavelength component L₁ incident from the output surface 21b penetrates the linear variable wavelength filter 21 and is received by the first photo detector 5-1 arranged in the position corresponding to the first incident position 21a₁.

Next, the mirror part 3a is moved by the driving mechanism 3b and arranged in a second position differing from the first position. The mirror part 3a causes the light L to be incident at the incident angle +θ₂ with respect to the second incident position 21a₂ on the incident surface 21a. It should be noted that the incident angle θ₁ and the incident angle θ₂ are different angles.

Regarding the second incident position 21a₂, from among the incident lights L, only the second wavelength component L₂ penetrates the linear variable wavelength filter 21 and reaches the reflection member 4. The reflection member 4 reflects the wavelength component L₂ and causes it to incident into the output surface 21b of the linear variable wavelength filter 21. The wavelength component L₂ incident from the output surface 21b penetrates the linear variable wavelength filter 21 and is received by the second photo detector 5-2 arranged in a position corresponding to the second incident position 21a₂.

By repeating these operations until reaching the nth incident position 21aₙ, it becomes possible to separate the plurality of wavelength components L₁ to Lₙ included in the light L using the spectrometer 1. It should be noted that, in actuality, the mirror part 3a is continuously moved. Accordingly, the light L reflected by the mirror part 3a is successively incident into the kth incident positions 21aₖ.

In the spectral analyzer 6, by means of analyzing the electric signals based on the wavelength components L₁ to Lₙ received by the photo detectors 5-1 to 5-n, information included in the respective wavelength components L₁ to Lₙ (for example, information from a server in the case of optical communication) may be extracted. It should be noted that regarding optical communication (the case in which information is assigned to each wavelength component), only the spectral distribution of the light L is obtained by a single measurement. By repeating measurements, the chronological change of each spectrum may be obtained and, ultimately, quality information (wavelength, power, SN ratio) of each wavelength component may be obtained.

### <Action and Effect of the First Embodiment>

The action and effect of the spectrometer related to the present embodiment is explained.

The illuminating means 3 provided in the spectrometer 1 causes light to be incident at respectively different incident angles with respect to the plurality of incident positions on the incident surface 2a of the filter part 2. The filter part 2 only transmits a particular wavelength component for each incident position. Accordingly, the respective wavelength components corresponding to the incident positions may be detected. That is, the invention according to the present embodiment does not require a lens (for example, the lens 48 according to Patent Document 1) for causing light to be perpendicularly incident into the filter part 2; therefore, the particular wavelength component may be separated from the light comprising the plurality of wavelength components by means of a small, simple configuration.

It should be noted that the position and number of the plurality of incident positions are determined from the number of wavelength components to be separated. That is, the photo detector 5 is required at a number corresponding to the number of wavelength components to be separated; as a result, the position on the incident surface 2a corresponding to this photo detector 5 is determined as the incident position thereof.

Moreover, the illuminating means 3 comprises a mirror part 3a that reflects the light L and a driving mechanism 3b that drives the mirror part 3a such that the light L is successively incident into the plurality of incident positions. Accordingly, it becomes possible to causing light to be successively incident with respect to the plurality of incident positions on the incident surface 2a of the filter part 2. Accordingly, there is little possibility of lights output from the second surface 2b of the filter part 2 interfering with each other; therefore, crosstalk between the lights may be suppressed.

Moreover, a reflection member 4 formed with a reflective surface 4a reflecting the light that has penetrated the filter part 2 is provided. In this case, for example, as illustrated in FIG. 5, the illuminating means 3 is arranged on the incident surface 2a side of the filter part 2, while the reflection member 4 is arranged on the output surface 2b side that is the opposite side of the incident surface 2a. The reflective surface 4a faces the output surface 2b and is non-parallelly arranged with the incident surface 2a. It should be noted that FIG. 5 is a diagram illustrating the inside of the spectrometer 1 as seen from the side surface (y-z direction).

In this case, the light L penetrates the filter part 2 twice; therefore, even when a plurality of wavelength components closer to a particular wavelength are included, only these wavelength components may be received by the corresponding photo detectors 5-k. That is, crosstalk may be suppressed. Further, by means of non-parallelly arranging the reflective surface 4a with respect to the incident surface 2a, it becomes possible to prevent the surface-reflected light L″ of the light L from the incident surface 2a from being incident onto the photo detector 5-k along with guiding the wavelength component Lₖ reflected by the reflective surface 4a to the photo detector 5-k.

Moreover, in the embodiment, the filter part 2 is configured by a linear variable wavelength filter 21. The wavelength component Lₖ penetrating the linear variable wavelength filter 21 differs depending on the incident position of the light L. Accordingly, by means of changing the angle of the light L (incident angle) incident into the respective incident positions, detection of the wavelength components over a wide range becomes possible. That is, even when the light L comprises wavelength components within a wide-range, the particular wavelength component may be separated by a simple configuration.

Moreover, the spectrometer 1 comprises the plurality of photo detectors 5 that is arranged in a position corresponding to the plurality of incident positions and detects the light that has penetrated the filter part 2. The positions of the photo detectors 5 are associated with the incident positions of light into the filter part 2, allowing the respective photo detectors 5-k to detect the particular wavelength components Lₖ via the corresponding incident positions. Accordingly, there is no need to perform calibration between the illuminating means 3 and the filter part 2.

### <Modified Example 1>

In the embodiment mentioned above, an explanation is provided for a configuration using the MEMS mirror, etc. as the illuminating means 3; however, it is not limited to this. As illustrated in FIG. 6, it is possible to apply a configuration in which a lens member 7 is used as the illuminating means 3 and the photo detector 5 is arranged on the output surface 2b side of the filter part 2.

The lens member 7 is, for example, a collimator lens, converting divergent light output from the fiber F into parallel light. The lens member 7 should be a member capable of causing the divergent light output from the fiber F to be substantially simultaneously incident with respect to the plurality of incident positions provided on the incident surface 2a of the filter part 2. Accordingly, the lens member 7 is not required to be configured to convert the divergent light into parallel light, as in the collimator lens.

The photo detector 5 is arranged on the output surface 2b side of the filter part 2, and receives the light Lₖ that has penetrated the filter part 2.

In this case, once the light L is irradiated, the different wavelength components included in the light L may be extracted; consequently, the time required for spectral diffraction may be shortened.

Moreover, as another example of the illuminating means 3, a non-driving (that is, with the position fixed) convex mirror may be used. Any detailed configuration of the illuminating means 3 is possible as long as it is capable of changing the direction of travel of the light L.

### <Modified Example 2>

In the embodiment mentioned above, an explanation is provided according to a configuration using a linear variable wavelength filter 21 as the filter part 2; however, it is not limited to this. For example, even regarding a band pass filter with uniform transmission characteristic, it is known that the penetrated wavelength differs as a result of the propagated distance of the light penetrating the band pass filter in relation to the incident angle of the light incident into the band pass filter. An example thereof is illustrated in FIG. 7. It should be noted that, in the graph of FIG. 7, the vertical axis shows the transmission peak wavelength (nm) while the horizontal axis shows the incident angle (deg).

That is, by means of changing the incident angle of the light incident into the band pass filter using the illuminating means 3, it becomes possible to separate a particular wavelength component from the light comprising different wavelength components by a simple configuration. Moreover, a band pass filter is easier to prepare compared to the linear variable wavelength filter 21. Accordingly, the manufacturing cost of the spectrometer 1 may be reduced.

### <Second Embodiment>

The spectrometer according to the present embodiment is explained with reference to FIGS. 8 to 12.

As illustrated in FIGS. 8 to 9C, the spectrometer 301 according to the present embodiment comprises a filter part 302, an illuminating means 303, a reflection member 304, a photo detector 305, and a spectral analyzer 306. FIG. 8 is a perspective diagram illustrating an example of the spectrometer 301. FIG. 9A is a side view of the spectrometer 301 (y-z direction of FIG. 8). FIG. 9B is a top view of the spectrometer 301 (x-y direction of FIG. 8). FIG. 9C is a perspective diagram illustrating the filter part 302 (filters 302a/302b/302c (mentioned later)) and the illuminating means 303 (a mirror part 303a (mentioned later)) in the spectrometer 301. In the present embodiment, the front direction when looking at the spectrometer 301 from the side surface (FIG. 9A) is the x direction (refer to FIG. 8 and FIG. 9B). Moreover, the short-side direction of the side surface of the spectrometer 301 is the y direction. Moreover, the long-side direction of the side surface of the spectrometer 301 (FIG. 9A) is the z direction. The dashed arrows in FIGS. 8 to 9C schematically illustrate an example of the pathway of the light L incident into the fiber F (refer to FIG. 8). The chain line arrows in FIGS. 8 to 9C schematically illustrate an example of the pathways of the wavelength component Lₖ (k=1 to n) that have penetrated the filter part 302.

### <Filter Part>

In the spectrometer 301, the filter part 302 is arranged in the position into which the light L from the illuminating means 303 is incident. It should be noted that, in the present embodiment and Modified Example 1, an explanation is provided for a configuration using a linear variable wavelength filter as the filter part 302 (filters 302a to 302c (mentioned later)). In Modified Example 2, an explanation is provided for a configuration using a band pass filter with uniform transmission characteristic. In Modified Example 3, an explanation is provided for a configuration using a filter with different center wavelengths of the wavelength components penetrating the plurality of incident positions in a specific direction, along with the center wavelengths of the wavelength components penetrating in a direction orthogonal to this specific direction.

The filter part 302 comprises a first surface 321 and a second surface 322 (refer to FIG. 9B). The first surface 321 and the second surface 322 are on opposite sides of each other. The first surface 321 and the second surface 322 have a two-dimensional expanse in the x-z direction. The light L from the illuminating means 303 is incident into the first surface 321. That is, the first surface 321 forms the incident surface of the filter part 302 (hereinafter, referred to as the “incident surface 321”). There are multiple positions on the incident surface 321 into which the light L is incident (hereinafter, referred to as the “incident position”). The filter part 302 transmits the specific wavelength components Lₖ of the light L incident with respect to the incident surface 321. From among the light L, only the specific wavelength components Lₖ are output from the second surface 322. That is, the second surface 322 forms the output surface of the filter part 302 (hereinafter, referred to as the “output surface 322”). The illuminating means 303 is arranged on the incident surface 321 side apart from the filter part 302 by a specific distance. The reflection member 304 is arranged on the output surface 322 side apart from the filter part 302 by a specific distance.

Further, in actuality, the thickness of the filter part 302 is formed thinner than the length of the optical path of the light L (the distance passed by the light L is shorter). Moreover, the distance between the reflection member 304 and the output surface 322 is formed shorter compared to the distance between the illuminating means 303 and the incident surface 321. Accordingly, the wavelength component Lₖ penetrating the filter part 302 from the incident surface 321 side and reflected by the reflection member 304 penetrates the filter part 302 from the output surface 321 side via the pathway β (refer to FIG. 9B) that is substantially the same as the pathway α (refer to FIG. 9B) of this wavelength component Lₖ penetrating the filter part 302 from the incident surface 2a side, and reaches the photo detector 305 (in each diagram, the depiction is exaggerated for easier understanding of the invention).

The filter part 302 in the present embodiment comprises a plurality of filters (a plurality of linear variable wavelength filters) 302a to 302c (refer to FIG. 9A and FIG. 9C). Each of the filters 302a to 302c comprises incident surfaces (first surfaces) 321a/321b/321c and output surfaces (second surfaces) 322a/322b/322c. The incident surfaces 321a to 321c and the output surfaces 322a to 322c are on opposite sides of each other. The incident surfaces 321a to 321c (output surface 322a to 322c) are formed substantially linearly such that the longer directions thereof are specific directions. In the present embodiment, the x direction is the longer direction.

It should be noted that the incident surfaces 321a to 321c have, in actuality, a two-dimensional expanse; however, in this specification, the incident surfaces 321a to 321c are treated as having a one-dimensional configuration (substantially linear).

The filters 302a to 302c are arranged in a direction orthogonal to the specific direction (longer direction: the x direction) such that the incident surfaces 321a to 321c (output surfaces 322a to 322c) forms the incident surface 302a having a two-dimensional expanse (refer to FIG. 9C). In the present embodiment, the z direction corresponds to the “direction orthogonal to the specific direction.”

The filter 302a transmits specific wavelength components Laₘ (m=1 to n) of the light L incident into the incident surface 321a. From among the light L incident from the incident surface 321a, only the specific wavelength component Laₘ is output from the output surface 322a. The filter 302b transmits specific wavelength components Lbₘ (m=1 to n) of the light L incident into the incident surface 321b. From among the light L incident from the incident surface 321b, only the specific wavelength component Lbₘ is output from the output surface 322b. The filter 302c transmits specific wavelength components Lcₘ (m=1 to n) of the light L incident into the incident surface 321c. From among the light L incident from the incident surface 321c, only the specific wavelength component Lcₘ is output from the output surface 322c. The specific wavelength components Laₘ to Lcₘ are different wavelength components from each other. That is, the filters 302a to 302c transmit different wavelength components from each other.

Here, a general configuration of the linear variable wavelength filter 500 used as the filters 302a to 302c is explained with reference to FIG. 10. FIG. 10 is a diagram illustrating the filter part 302 (linear variable wavelength filter 500) as seen from the top surface of the spectrometer 301.

The linear variable wavelength filter 500 comprises a incident surface 501 (a first surface 321) and an output surface 502 (a second surface 322). The light L′ from the illuminating means 303 is incident into the incident surface 501. The incident direction thereof is determined by the direction of the reflective surface 331a (mentioned later) of the illuminating means 303. The incident surface 501 is specifically inclined with respect to the longer direction of the output surface 502 (second surface 322) on the opposite side thereof. Even when the light L comprising the plurality of wavelength components L′aₖ (k=1 to n) is incident from the incident surface 501, the wavelength components L′aₖ that penetrate differ depending on the incident position thereof (refer to FIG. 10). That is, the linear variable wavelength filter is capable of separating the particular wavelength component from the light comprising the plurality of wavelength components.

### <Illuminating Means>

The illuminating means 303 causes the light L guided by the optical fiber F, etc. and incident into the spectrometer 301 to be incident at respectively different incident angles with respect to the plurality of incident positions with two-dimensionally different positions on the incident surface 321 (incident surfaces 321a to 321c). The incident angle of the present embodiment is the angle expressed by the inclination of the light L with respect to a normal line, with the normal line when the illuminating means 303 is in the initial position as the standard. It should be noted that the “initial position” refers to the position of the mirror part 303a when, for example, the output surface 322 of the filter part 302 and the reflective surface 331a of the mirror part 303a are parallel.

The illuminating means 303 comprises a mirror part 303a and a driving mechanism 303b. The mirror part 303a comprises a reflective surface 331a that reflects the light L incident into the spectrometer 301. A driving mechanism 303b rotates the mirror part 303a with respect to the axis of rotation O1 (refer to FIG. 9B and FIG. 9C) based on control signals from a controller (not illustrated), etc., thereby successively causing the light L reflected by the reflective surface 331a to be incident into the plurality of incident positions in the x-direction on the incident surface 302a. Moreover, the driving mechanism 303b rotates the mirror part 303a with respect to the axis of rotation O2 (refer to FIG. 9A and FIG. 9C) based on control signals from the controller (not illustrated), etc., thereby successively causing the light reflected by the reflective surface 331a to be incident into the plurality of incident positions in the z direction on the incident surface 321. The illuminating means 303 is, for example, the MEMS (Micro Electro Mechanical Systems) mirror or a polygon mirror.

Moreover, it is possible to apply a configuration in which the illuminating means 303 does not comprise the driving mechanism 303b. As an example thereof, a diverging member, such as a concave lens, etc., capable of diverging the light L is arranged on the output end of the optical fiber F guiding the light L into the spectrometer 301. Moreover, the illuminating means 303 is a member such as a mirror, etc. The illuminating means 303 is fixed in a position capable of simultaneously causing the light L diverged by the diverging member to be incident with respect to the plurality of incident positions on the incident surface 321. It should be noted that, in this case, the timings for detecting the plurality of wavelength components Lₖ included in the light L irradiated at a certain timing using the photo detector 305 should be the same. Accordingly, the light L should be substantially simultaneously incident into the plurality of incident positions on the incident surface 321.

Here, in the cases of causing the diverged light to be incident with respect to the filter part 302 (the incident surface 321), there is a possibility of the amount of light incident into the edge part of the incident surface 321 being weaker compared to the central part of the incident surface 321. In such cases, by, for example, considering the distribution of the intensity of light L projected onto the incident surface 321 with respect to the result of light reception by the photo detector 5 in the spectral analyzer 6, it is possible to perform a correction processing using coefficients for cancelling this distribution, thereby suppressing the dispersion of light intensity.

### <Reflection Member>

The reflection member 304 is an optical element such as a mirror, etc. The reflection member 304 is arranged on the output surface 322 side of the filter part 302. The reflection member 304 is formed with a reflective surface 304a reflecting the wavelength component Lₖ that has penetrated the filter part 302. The reflective surface 304a faces the output surface 322, and is parallelly arranged with respect to the longer direction thereof (refer to FIG. 9B). As a result, the reflective surface 304a is non-parallelly arranged with respect to the incident surface 321 (refer to FIG. 9A and FIG. 9B). The wavelength component L_{K} reflected by the reflective surface 304a is, as mentioned above, lead to the photo detector 305 via the pathway β (refer to FIG. 9B) that is substantially the same as the pathway α (refer to FIG. 9B) in which the light L has penetrated the filter part 302. The reflection member 304 is formed with the same length as the length in the longer direction of the output surface 322 such that the wavelength component Lₖ output from the output surface 322 may be reflected.

By means of arranging the reflection member 304 on the output surface 322 side of the filter part 302, the wavelength component Lₖ corresponding to the particular wavelength λₖ (k=1 to n) that has penetrated the filter part 302 is reflected by the reflection member 304 and is incident into the filter part 302 again from the output surface 322 side. Accordingly, for the case in which the light L is incident from the incident surface 321 side of the filter part 302, even when only the wavelength component Lₖ corresponding to the particular wavelength λₖ cannot be separated (even in the event of so-called crosstalk occurs), by means of causing the wavelength component Lₖ to pass through the filter part 2 again (by means of causing it to be incident from the output surface 322 side), it becomes possible to transmit only the wavelength component Lₖ corresponding to the particular wavelength λₖ. That is, the detection selectivity of the wavelength component may be enhanced.

### <Photo Detector>

The photo detector 305 receives the wavelength component Lₖ that has penetrated the filter part 302. The photo detector 305 is, for example, a PD (Photo Detector). The photo detector 305 is provided in pluralities in the positions corresponding to the plurality of incident positions of the incident surface 321 (refer to FIG. 9B). That is, there is a one-to one correspondence between the plurality of photo detectors 305-k (k=1 to n) and the plurality of incident positions. In the present embodiment, the plurality of incident positions on the incident surface 321 has a two-dimensional expanse. Accordingly, the plurality of photo detectors 305-k are also arranged as a two-dimensional expanse corresponding to the incident position.

Here, in Patent Document 1, when detecting particular wavelength components, it is difficult to determine whether or not light may be accurately projected onto the positions of the LVF50 corresponding to the wavelength components thereof and further, to determine whether or not the particular wavelength components have passed through the corresponding positions thereof. Accordingly, calibration between the angle of the cyclically pivotable mirror 38 with respect to the LVF50 is required each time the spectrometer is used, making it troublesome for the user; moreover, there is also a concern that this may lead to declined detection accuracy.

In contrast, the positions of the photo detector 305 is associated with the incident position of the light L with regard to the filter part 302, allowing the photo detector 305 receiving the wavelength component Lₖ comprised in the light L incident into a certain incident position to be determined. Accordingly, it becomes possible to separate the particular wavelength component Lₖ from the light L comprising the plurality of wavelength components L₁ to Lₙ without having to carry out calibration between the illuminating means 303 and the filter part 302.

### <Spectral Analyzer>

The spectral analyzer 306 analyzes electric signals based on the wavelength component Lₖ received by the photo detector 305 and extracts the information included in this wavelength Lₖ.

It should be noted that, in the present embodiment, an explanation is provided regarding the configuration of the spectrometer 301 including the filter part 302, the illuminating means 303, the reflection member 304, the photo detector 305, and the spectral analyzer 306; however, the configuration of the spectrometer 301 is not limited to this. For example, if the photo detector 305 is arranged on the output surface 322 side of the filter part 302, the reflection member 304 is not required. Accordingly, the configuration of the spectrometer 301 may be simplified. In this case as well, the photo detector 305 is provided in pluralities at positions corresponding to the plurality of incident positions of the incident surface 321.

Moreover, the photo detector 305 and the spectral analyzer 306 may be provided as a different body from the spectrometer 301 (for example, outside the spectrometer 301). That is, the spectrometer of the present invention may comprise at least the filter part 302 and the illuminating means 303.

### <Progression of Light>

Next, the progression of the light L in the spectrometer 301 of the present embodiment is explained with reference to FIG. 11. FIG. 11 is a diagram illustrating the inside of the spectrometer 301 as seen from the top side (x-y direction). It should be noted that, in FIG. 11, n rays of light L are illustrated such that they are reflected at different positions on the illuminating means 303 for the convenience of explanation; however, in actuality, each light L is reflected at substantially the same position on the illuminating means 303. In the configuration illustrated in FIG. 11, the linear variable wavelength filters 302a/302b/302c are used as the filter part 302 and the MEMS mirror is used as the illuminating means 303. FIG. 11 illustrates an example of the light L incident into the spectrometer 301 via the optical fiber F penetrating the linear variable wavelength filters 302a/302b/302c from the illuminating means 303, and the wavelength components Laₘ (Lbₘ/Lcₘ:m=1 to n) separated by this filter being reflected by the reflection member 304, leading to the photo detectors 351-k (352-k/353-k: k=1 to n). It is regarded that there are n number of incident positions on the incident surfaces 321a/321b/321c of the linear variable wavelength filters 302a/302b/302c. These are regarded as the incident positions 321aₖ /321bₖ /321cₖ (k=1 to n). Regarding the incident angles θₖ (k=1 to n) at which the light L is incident with respect to the incident positions 321aₖ/321bₖ/321cₖ, with the normal line N (refer to FIG. 11) when the MEMS mirror is at the initial position as the standard (that is, θₖ=0), the direction at which the thickness of the linear variable wavelength filters 302a/302b/302c becomes thicker (+x direction) is regarded as positive and the direction at which it gets thinner (−x direction) is regarded as negative. It is regarded that the photo detectors 351-k/352-k/353-k are provided as the photo detector 305 in the position corresponding to the incident positions 321aₖ/321bₖ/321cₖ. In FIG. 11, the refraction at the boundary surfaces of the linear variable wavelength filters 302a/302b/302c (incident surfaces 321a/321b/321c and the output surfaces 322a/322b/322c) is ignored. It should be noted that FIG. 11 is a diagram illustrating the inside of the spectrometer 301 as seen from the top side, wherein the illuminating means 303, the linear variable wavelength filter 302a (302b, 302c), the reflection member 304, and the photo detectors 3051-k (352-k, 353-k) are illustrated such that they seem to be on the same plane; however, in actuality, their z positions are different, as illustrated in FIG. 9A.

First, the mirror part 303a of the MEMS mirror is moved from the initial position to the first position. The “first position” is the position (direction) of the mirror part 303a in which the light L from the optical fiber may be incident into the first incident position 321a₁ on the incident surface 321a of the linear variable wavelength filter 302a.

The light L from the optical fiber is guided to the mirror part 303a in the first position. The mirror part 303a causes the light L from the optical fiber to be incident at the incident angle +θ₁ with respect to the first incident position 321a₁.

In the first incident position 321a₁, from among the incident light L, only the first wavelength component La₁ penetrates the linear variable wavelength filter 302a and leads to the reflection member 304. The reflection member 304 (the reflective surface 304a) reflects the wavelength component La₁ and causes it to be incident into the output surface 322a of the linear variable wavelength filter 302a. The wavelength component L₁ incident from the output surface 322a penetrates the linear variable wavelength filter 302a and is received by the first photo detector 351-1 arranged in the position corresponding to the first incident position 321a₁.

Next, the mirror part 303a is moved by the driving mechanism 303b and arranged in a second position differing from the first position. The mirror part 303a causes the light L at the incident angle +θ₂ with respect to the second incident position 321a₂ on the incident surface 321a. It should be noted that the incident angle θ₁ and the incident angle θ₂ are different angles.

Regarding the second incident position 321a₂, from among the incident lights L, only the second wavelength component La₂ penetrates the linear variable wavelength filter 302a and leads to the reflection member 304. The reflection member 304 reflects the wavelength component La₂ and causes it to be incident into the output surface 322a of the linear variable wavelength filter 302a. The wavelength component La₂ incident from the output surface 322a penetrates the linear variable wavelength filter 302a and is received by the second photo detector 351-2 arranged in the position corresponding to the second incident position 321a₂.

In the same manner, the mirror part 303a is moved by the driving mechanism 303b and arranged in the nth position. The mirror part 303a causes the light L to be incident at the incident angle −θₙ with respect to the nth incident position 321aₙ on the incident surface 321a.

In the nth incident position 321aₙ, from among the incident light L, only the nth wavelength component Laₙ penetrates the linear variable wavelength filter 302a and leads to the reflection member 304. The reflection member 304 reflects the wavelength component Laₙ and causes it to be incident into the output surface 322a of the linear variable wavelength filter 302a. The wavelength component Laₙ incident from the output surface 322a penetrates the linear variable wavelength filter 302a and is received by the nth photo detector 351-n arranged in the position corresponding to the first incident position 321aₙ.

The operations mentioned above are similarly applied to the cases of the linear variable wavelength filter 302b and the linear variable wavelength filter 302c.

That is, by means of the driving mechanism 303b, the mirror part 303a is rotated with respect to the axis of rotation O2 as the axis, and is moved to the first position on the linear variable wavelength filter 302b. The mirror part 303a causes the light L to be incident at the incident angle +θ₁ with respect to the first incident position 321b₁ on the incident surface 321b.

Regarding the first incident position 321b₁ on the linear variable wavelength filter 302b, from among the incident light L, only the first wavelength component Lb₁ penetrates and leads to the reflection member 304. The reflection member 304 reflects the wavelength component Lb₁ and causes it to be incident into the output surface 322b of the linear variable wavelength filter 302b. The wavelength component Lb₁ incident from the output surface 322b penetrates the linear variable wavelength filter 302b and is received by the first photo detector 352-1 arranged in the position corresponding to the first incident position 321b₁.

In the same manner, the mirror part 303a is moved by the driving mechanism 303b and arranged in the nth position. The mirror part 303a causes the light L to be incident at the incident angle −θₙ with respect to the nth incident position 321bₙ on the incident surface 321b.

Regarding the nth incident position 321bₙ, from among the incident light L, only the nth wavelength component Lbₙ penetrates the linear variable wavelength filter 302b and leads to the reflection member 304. The reflection member 304 reflects the wavelength component Lbₙ and causes it to be incident into the output surface 322b of the linear variable wavelength filter 302b. The wavelength component Lbₙ incident from the output surface 322b penetrates the linear variable wavelength filter 302b and is received by the nth photo detector 352-n arranged in the position corresponding to the nth incident position 321bₙ.

Moreover, by means of the driving mechanism 303b, the mirror part 303a is rotated with respect to the axis of rotation O2 as the axis, and is moved to the first position on the linear variable wavelength filter 302c. The mirror part 303a causes the light L to be incident at the incident angle +θ₁ with respect to the first incident position 321cᵢ on the incident surface 321c.

Regarding the first incident position 321c₁ on the linear variable wavelength filter 302c, from among the incident light L, only the first wavelength component Lc₁ penetrates and leads to the reflection member 304. The reflection member 304 reflects the wavelength component Lc₁ and causes it to be incident into the output surface 322c of the linear variable wavelength filter 302c. The wavelength component Lc₁ incident from the output surface 322c penetrates the linear variable wavelength filter 302c and is received by the first photo detector 353-1 arranged in the position corresponding to the first incident position 321c₁ (refer to FIG. 13).

In the same manner, the mirror part 303a is moved by the driving mechanism 303b and arranged in the nth position. The mirror part 303a causes the light L to be incident at the incident angle −θₙ with respect to the nth incident position 321cₙ on the incident surface 321c.

Regarding the nth incident position 321cₙ, from among the incident light L, only the nth wavelength component Lcₙ penetrates the linear variable wavelength filter 302c and leads to the reflection member 304. The reflection member 304 reflects the wavelength component Lcₙ and causes it to be incident into the output surface 322c of the linear variable wavelength filter 302c. The wavelength component Lcₙ incident from the output surface 322c penetrates the linear variable wavelength filter 302c and is received by the nth photo detector 353-n arranged in the position corresponding to the nth incident position 321cₙ.

By means of these operations, it becomes possible to separate the plurality of wavelength components Laₘ to Lcₘ included in the light L using the spectrometer 301. It should be noted that, in actuality, the mirror part 303a is continuously moved. Accordingly, the light L reflected by the mirror part 303a is successively incident into the filter part 302 (the linear variable wavelength filters 302a to 302c).

In the spectral analyzer 306, by means of analyzing the electric signals based on the wavelength components La₁ to Lcₙ received by the photo detectors 351-1 to 353-n, information included in the respective wavelength components La₁ to Lcₙ (for example, information from a server in the case of optical communication) may be extracted. It should be noted that, regarding optical communication (the case in which information is assigned to each wavelength component), only the spectral distribution of the light L is obtained by a single measurement. By repeating measurements, the chronological change of each spectrum may be obtained and, ultimately, quality information (wavelength, power, SN ratio) of each wavelength component may be obtained.

### <Action and Effect of the Second Embodiment>

The action and effect of the spectrometer related to the present embodiment is explained.

The illuminating means 303 provided in the spectrometer 301 causes light at respectively different incident angles with respect to the plurality of incident positions on the incident surface 321 with a two-dimensional expanse of the filter part 302. The filter part 302 only transmits a particular wavelength component for each incident position. In particular, the filter part 302 of the present embodiment includes the filters 302a to 302c for transmitting the specific wavelength components of the light incident into the incident surface 321 that comprise the substantially linearly-formed incident surface 321 with the longer direction thereof being a specific direction. The filters 302a to 302c transmit respectively different specific wavelength components. The filters 302a to 302c are arranged in the direction orthogonal to the specific direction. Accordingly, the multiple wavelength components corresponding to the multiple incident position may be detected. In other words, the invention according to the present embodiment does not require a lens (for example, the lens 48 according to Patent Document 1) for causing perpendicular light into the filter part 302; therefore, particular wavelength components may be separated from broadband light by means of a small, simple configuration.

It should be noted that the position and number of the plurality of incident positions are determined by the number of wavelength components to be separated. That is, the photo detector 305 is required in a number corresponding to the number of wavelength components to be detected; as a result, the position on the incident surface 321 corresponding to the relevant photo detector 305 is determined as the incident position.

Moreover, the illuminating means 303 comprises the mirror part 303a that reflects the light L and the driving mechanism 303b that drives the mirror part 303a for successively causing the light L to be incident into the plurality of incident positions. Accordingly, it becomes possible to successively cause light to be incident into the plurality of incident positions on the incident surface 321 of the filter part 302. Accordingly, there is little possibility of the light output from the second surface 322 of the filter part 302 interfering with each other; therefore, crosstalk between the lights may be suppressed.

Moreover, a reflection member 304 formed with the reflective surface 304a reflecting light that has penetrated the filter part 302 is provided. In this case, for example, as illustrated in FIG. 12, the illuminating means 303 is arranged on the incident surface 321 side of the filter part 302, while the reflection member 304 is arranged on the output surface 322 side, which is the opposite side of the incident surface 321. The reflective surface 304a faces the output surface 322 and is non-parallelly arranged with the incident surface 321. It should be noted that FIG. 12 is a diagram illustrating the inside of the spectrometer 301 as seen from the side surface (y-z direction).

In this case, the light L penetrates the filter part 302 twice; therefore, even when a plurality of wavelength components Lₖ close to the particular wavelength are included, the specific wavelength component Lₖ may be received by the corresponding photo detector 305-k. That is, crosstalk may be suppressed. Further, by means of non-parallelly arranging the reflective surface 304a to the incident surface 321, it becomes possible to prevent the surface-reflected light L″ of the light L from the incident surface 321 from being incident onto the photo detector 5-k along with guiding the wavelength component Lₖ reflected by the reflective surface 4a to the photo detector 305-k.

Moreover, in the embodiment, the filter part 302 is configured by the linear variable wavelength filters 302a/302b/302c. The wavelength component Lₖ penetrating the linear variable wavelength filter 302a/302b/302c differs depending on the incident position of the light L. Accordingly, by means of changing the angle (incident angle) of the light L incident into the respective incident positions, detection of the wavelength component over a wide range becomes possible. That is, even when the light L comprises wavelength components within a wide-range, the particular wavelength component may be separated by a simple configuration.

Moreover, the spectrometer 301 comprises the plurality of photo detectors 305 that are arranged in a position corresponding to the plurality of incident positions and receive the light that has penetrated the filter part 302. The position of the photo detector 305 is associated with the incident position of the light towards the filter part 302, allowing the respective photo detectors 305-k to detect the particular wavelength component Lₖ via the corresponding incident position. Accordingly, there is no need to calibrate the illuminating means 303 and the filter part 302.

### <Modified Example 1>

In the embodiment mentioned above, an explanation is provided for a configuration using the MEMS mirror, etc. as the illuminating means 303; however, it is not limited to this. As illustrated in FIG. 13, a configuration is possible using the lens member 307 as the illuminating means 303 and arranging the photo detector 305 on the output surface 322 side of the filter part 302.

The lens member 307 is, for example, the collimator lens, converting divergent light output from the fiber F into parallel light. The lens member 307 should be a member capable of substantially simultaneously causing the divergent light output from the fiber F to be incident with respect to the plurality of incident positions provided on the incident surface 321 of the filter part 302. Accordingly, the lens member 307 is not required to be configured to convert the divergent light into parallel light, as in the collimator lens.

The photo detector 305 is arranged on the output surface 322 side of the filter part 302, and receives the light Lₖ that has penetrated the filter part 302.

In this case, once the light L is irradiated, the different wavelength components included in this light L may be extracted; consequently, the time required for spectral diffraction may be shortened.

Moreover, as another example of the illuminating means 303, the non-driving (that is, with the position fixed) convex mirror may be used. Any detailed configuration of the illuminating means 303 is possible as long as it is capable of changing the direction of progression of the light L.

### <Modified Example 2>

In the embodiment mentioned above, an explanation is provided according to a configuration using a plurality of linear variable wavelength filters as the filter part 302; however, it is not limited to this. For example, even regarding a band pass filter with uniform transmission characteristic, it is known that the penetrated wavelength differs as a result of the propagated distance of the light passing through the band pass filter depending on the incident angle of the light incident into the band pass filter. An example thereof is illustrated in FIG. 14. It should be noted that, in the graph of FIG. 14, the vertical axis shows the transmission peak wavelength (nm) while the horizontal axis shows the incident angle (deg).

That is, by means of providing a plurality of band pass filters with such configuration and changing the incident angle of the light incident into these band pass filters using the illuminating means 303, it becomes possible to separate the particular wavelength component from the light comprising different wavelength components by a simple configuration. Moreover, the band pass filter is easier to prepare compared to the linear variable wavelength filter. Accordingly, the manufacturing cost of the spectrometer 301 may be reduced.

### <Modified Example 3>

Moreover, it is also possible to use the filter 510 as illustrated in FIG. 15 as the filter part 302. FIG. 15 is a diagram illustrating the filter 510 as seen from the incident surface 510a side. In this modified example, an explanation is provided with the long-side direction of the filter 510 as the x direction and the short-side direction of the filter 510 as the y direction.

The filter 510 is a single filter having the incident surface 510a with a two-dimensional expanse in the xy direction. The filter 510 comprises, for example, the plurality of incident positions 510aₖ to 514aₖ (k=1 to n).

The filter 510 has different thickness along the first direction (x-direction). That is, the center wavelengths λₖ of the wavelength components Lₖ penetrating through the plurality of incident positions 510aₖ (k=1 to n) in the x-direction are different in the respective incident positions 510aₖ.

Meanwhile, the filter 510 has uniform thickness in the direction orthogonal to the x-direction (y-direction; second direction). That is, it is formed such that the center wavelengths λₖ of the wavelength components Lₖ penetrating in the y-direction are equal. For example, the center wavelength λₖ of the wavelength component Lₖ penetrating the incident position 510a₁ and the center wavelength λₖ of the wavelength component Lₖ penetrating the incident positions 511a₁ to 514a₁ become equal.

When light is incident into the filter 510 by the illuminating means 303, the incident angle in the y-direction is respectively different for the incident positions 510aₖ to 514aₖ. Accordingly, it becomes possible to separate each wavelength component in the y-direction as well as the x-direction. That is, even in the case of using a single filter 510, the particular wavelength component may be separated from the broadband light by a simple configuration.

### EXPLANATION OF THE SYMBOLS

1 spectrometer

2 filter part

2a first surface (incident surface)

2b second surface (output surface)

3 illuminating means

3a mirror part

3b driving mechanism

4 reflection member

4a reflective surface

5 photo detector

6 spectral analyzer

301 spectrometer

302 filter part

302a, 302b, 302c filter (linear variable wavelength filter)

303 illuminating means

303a mirror part

303b driving mechanism

304 reflection member

304a reflective surface

305 photo detector

306 spectral analyzer

321a, 321b, 321c first surface (incident surface)

322a, 322b, 322c second surface (output surface)

What is claimed is:

1. A spectrometer, comprising:
a filter part configured to transmit a specific wavelength component of light incident onto an incident surface; and
an illuminating means configured to cause the light to be incident at respectively different incident angles onto a plurality of incident positions at different positions in the longer direction of the incident surface.

2. The spectrometer according to claim 1, wherein the illuminating means comprises:
a mirror part configured to reflect the light; and
a driving mechanism configured to drive the mirror part such that the light is successively incident onto the plurality of incident positions.

3. The spectrometer according to claim 1, wherein the illuminating means substantially simultaneously causes the light to be incident onto the plurality of incident positions.

4. The spectrometer according to claim 1, comprising a reflection member configured to be formed with a reflective surface that reflects light penetrated the filter part, wherein
the illuminating means is arranged on the first surface side of the filter part,
the reflection member is arranged on the second surface side that is the opposite side of the first surface, and
the reflective surface faces the second surface and is non-parallelly arranged with respect to the incident surface.

5. The spectrometer according to claim 4, wherein the reflective surface is non-parallelly arranged with respect to the incident surface such that while guiding the light reflected from the reflective surface to a photo detector, the surface-reflected light of the light from the first surface side is not incident onto the photo detector.

6. The spectrometer according to claim 1, wherein the filter part is a linear variable wavelength filter.

7. The spectrometer according to claim 1, comprising a plurality of photo detectors configured to be arranged at positions corresponding to the plurality of incident positions and to receive the light penetrated the filter part.

8. The spectrometer, comprising:
a filter part configured to transmit a particular wavelength component of the light incident onto an incident surface with two-dimensional expanse; and
an illuminating means configured to cause the light to be incident at respectively different incident angles onto a plurality of incident positions on the incident surface that are two-dimensionally different positions.

9. The spectrometer according to claim 8, wherein the illuminating means comprises:
a mirror part configured to reflect the light; and
a driving mechanism configured to drive the mirror part such that the light is successively incident onto the plurality of incident positions.

10. The spectrometer according to claim 8, wherein the illuminating means substantially simultaneously causes the light to be incident onto the plurality of incident positions.

11. The spectrometer according to claim 8, comprising a reflection member configured to be formed with a reflective surface that reflects light penetrated the filter part, wherein
the illuminating means is arranged on the first surface side of the filter part,
the reflection member is arranged on the second surface side that is the opposite side of the first surface, and
the reflective surface faces the second surface and is non-parallelly arranged with respect to the incident surface.

12. The spectrometer according to claim 11, wherein the reflective surface is non-parallelly arranged with respect to the incident surface such that while guiding the light reflected from the reflective surface to a photo detector, the surface-reflected light of the light from the first surface side is not incident onto the photo detector.

13. The spectrometer according to claim 8, wherein the filter part is a linear variable wavelength filter.

14. The spectrometer according to claim 8, comprising a plurality of photo detectors configured to be arranged at positions corresponding to the plurality of incident positions and to receive the light penetrated the filter part.

15. The spectrometer according to claim 8, wherein
the filter part comprises a plurality of filters configured to comprise a substantially linear incident surface in which the longer direction is a specific direction and to transmit particular wavelength components of the light incident onto the incident surface,
transmission wavelength components of the plurality of filters are different from each other, and
the plurality of filters are arranged in a direction orthogonal to the specific direction.

16. The spectrometer according to claim 8, wherein
the filter part comprises a single filter having an incident surface with two-dimensional expanse,
this filter is formed such that center wavelengths of transmission wavelength components are different along a first direction on the incident surface, and center wavelengths of transmission wavelength components are equal along a second direction that is orthogonal to the first direction.
